(19) United States
(12) Patent Application Publication
(10) Pub. No.: US 2026/0195426 A1
(43) Pub. Date: Jul. 9, 2026

(54) AUTHENTICATION METHOD, APPARATUS, COMMUNICATION DEVICE, AND STORAGE MEDIUM

(71) Applicant: Beijing Xiaomi Mobile Software Co., Ltd., Beijing (CN)

(72) Inventors: Haoran LIANG, Beijing (CN); Wei LU, Beijing (CN)

(73) Assignee: Beijing Xiaomi Mobile Software Co., Ltd., Beijing (CN)

(21) Appl. No.: 18/869,349

(22) PCT Filed: May 31, 2022
(86) PCT No.: PCT/CN2022/096480

§ 371 Date: Nov. 26, 2024

(51) Int. Cl. G06F 21/31

(52) U.S. Cl. CPC G06F 21/31

(57) ABSTRACT

Disclosed are an authentication method, an apparatus, a communication device, and a storage medium, the method including: performing, by a core network device, an identity authentication on a personal IoT networks element (PINE), where the PINE accesses the first type network through a PIN element with gateway capability (PEGC), and the PINE and the PEGC are connected through a second type network.

### CROSS-REFERENCE TO RELATED APPLICATION

The application is a U.S. National Stage of International Application No. PCT/CN2022/096480 filed on May 31, 2022, the entire content of which is incorporated herein by reference.

### TECHNICAL FIELD

The present application relates to the technical field of wireless communication but is not limited to the technical field of wireless communication, and in particular, relates to an authentication method, apparatus, communication device and storage medium.

### BACKGROUND

Personal IoT Networks (PIN) refers to the Internet of Things surrounding personal and home scenarios. There are three types of devices (A.K.A PIN Element) included in the PIN: a device with gateway capability, such as a personal IoT networks gateway (A.K.A PIN Element with Gateway Capability, PEGC), a device with management capability (A.K.A PIN Element with Management Capability, PEMC) and a device without gateway and management functions, such as a PIN Element (PINE). The PEGC and PEMC are user equipment (UE) that can access the fifth generation cellular mobile communication system (5^{th} Generation System, 5GS) directly. The PEMC is also able to access the 5GS via the PEGC. The PINE is not able to directly access the 5GS.

### SUMMARY

Embodiments of the present disclosure provide an authentication method, apparatus, communication device, and storage medium.

According to a first aspect of the embodiments of the present disclosure, an authentication method is provided, which is performed by a core network device of a first type network, and includes:
performing an identity authentication on a personal IoT networks element (PINE), where the PINE accesses the first type network through a PIN element with gateway capability (PEGC), and the PINE and the PEGC are connected through a second type network.

In one embodiment, performing the identity authentication on the PINE includes:
determining an expected authentication parameter based on at least a first credential and a calculation parameter of the PINE;
performing the identity authentication on the PINE based on the expected authentication parameter.

According to a second aspect of the embodiments of the present disclosure, an authentication method is provided, which is performed by a PIN element with gateway capability (PEGC), and includes:
transmitting authentication information during an identity authentication procedure of a personal IoT networks element (PINE) by a core network device of a first type network, where the PINE accesses the first type network through the PEGC, and the PINE and the PEGC are connected through a second type network.

According to a third aspect of the embodiments of the present disclosure, an authentication method is provided, which is performed by a PINE, and includes:
transmitting authentication information during an identity authentication procedure of the PINE by a core network device of a first type network, where the PINE accesses the first type network through a PIN element with gateway capability (PEGC), and the PINE and the PEGC are connected through a second type network.

According to a fourth aspect of the embodiments of the present disclosure, an authentication apparatus is provided, which is applied to a core network device of a first type network, and includes:
a processing module, configured to perform an identity authentication on a PINE, where the PINE accesses a first type network through a PIN element with gateway capability (PEGC), and the PINE and the PEGC are connected through a second type network.

According to a fifth aspect of the embodiments of the present disclosure, an authentication apparatus is provided, which is applied to a private Internet of Things gateway PEG, and includes:
a transceiver module, configured to transmit authentication information during an identity authentication procedure of a PINE by a core network device of a first type network, where the PINE accesses the first type network through the PEGC, and the PINE and the PEGC are connected through a second type network.

According to a sixth aspect of the embodiments of the present disclosure, an authentication apparatus is provided, which is applied to a PINE, and includes:
a transceiver module, configured to transmit authentication information during an identity authentication procedure of the PINE by a core network device of a first type network, where the PINE accesses the first type network through a PIN element with gateway capability (PEGC), and the PINE and the PEGC are connected through a second type network.

According to a seventh aspect of the embodiments of the present disclosure, a communication device apparatus is provided, including a processor, a memory, and an executable program stored on the memory and capable of being run by the processor, where when running the executable program, the processor executes steps of the authentication method described in the first aspect, the second aspect, or the third aspect.

According to an eighth aspect of the embodiments of the present disclosure, there is provided a storage medium on which an executable program is stored, where when the executable program is executed by a processor, steps of the authentication method described in the first aspect, the second aspect, or the third aspect are implemented.

It should be understood that the above general description and the following detailed description are only exemplary and explanatory, and do not limit the embodiments of the present disclosure.

### BRIEF DESCRIPTION OF THE DRAWINGS

The accompanying drawings, which are incorporated in and constitute a part of this specification, illustrate the embodiments consistent with the present disclosure, and together with the specification, serve to explain the principles of the embodiments of the present disclosure,

FIG. 1 is a schematic structural diagram of a wireless communication system according to an exemplary embodiment;

FIG. 2 is a schematic flowchart of an authentication method according to an exemplary embodiment:

FIG. 3 is a schematic flowchart of a method for triggering a core network device to perform authentication according to an exemplary embodiment;

FIG. 4 is a schematic flowchart of an authentication method according to an exemplary embodiment;

FIG. 5 is a schematic flowchart of an authentication method according to an exemplary embodiment;

FIG. 6 is a schematic flowchart of an authentication method according to an exemplary embodiment;

FIG. 7 is a schematic flowchart of an authentication method according to an exemplary embodiment;

FIG. 8 is a schematic flowchart of an authentication method according to an exemplary embodiment:

FIG. 9 is a schematic flowchart of an authentication method according to an exemplary embodiment;

FIG. 10 is a schematic diagram of authentication interaction according to an exemplary embodiment;

FIG. 11 is a block diagram of an authentication apparatus according to an exemplary embodiment;

FIG. 12 is a block diagram of an authentication apparatus according to an exemplary embodiment;

FIG. 13 is a block diagram of an authentication apparatus according to an exemplary embodiment; and

FIG. 14 is a block diagram of an apparatus for authentication according to an exemplary embodiment.

### DETAILED DESCRIPTION

Exemplary embodiments will be described in detail herein, examples of which are illustrated in the accompanying drawings. When the following description refers to the drawings, the same numbers in different drawings refer to the same or similar elements unless otherwise indicated. The implementations described in the following exemplary embodiments do not represent all implementations consistent with the embodiments of the present disclosure. Rather, they are merely examples of apparatus and methods consistent with some aspects of the embodiments of the present disclosure.

The terms used in the embodiments of the present disclosure are for the purpose of describing specific embodiments only and are not intended to limit the embodiments of the present disclosure. As used in the embodiments and the claims of the present disclosure, the singular forms “a/an,” “said” and “the” are intended to include the plural forms as well, unless the context clearly dictates otherwise. It should also be understood that the term “and/or” as used herein refers to and includes any or all possible combinations of one or more of the associated listed items.

It should be understood that although the terms first, second, third, etc. may be used to describe various information in the embodiments of the present disclosure, the information should not be limited to these terms. These terms are only used to distinguish information of the same type from each other. For example, without departing from the scope of the embodiments of the present disclosure, the first information may also be called second information, and similarly, the second information may also be called first information. Depending on the context, the word “if” as used herein may be interpreted as “when” or “upon” or “in response to determining.”

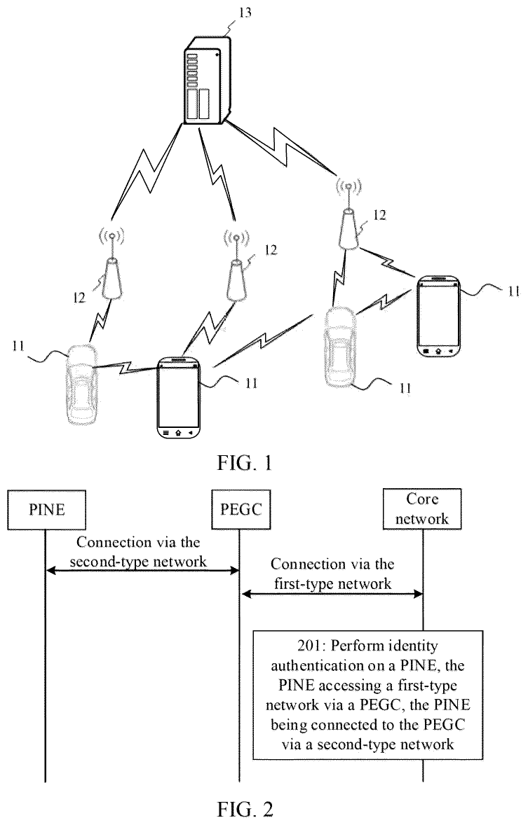

Referring to FIG. 1, a schematic structural diagram of a wireless communication system provided by an embodiment of the present disclosure is shown. As shown in FIG. 1, the wireless communication system is a communication system based on cellular mobile communication technology. The wireless communication system may include: several terminals 11 and several base stations 12.

The terminal 11 may be a device that provides voice and/or data connectivity to the user. The terminal 11 may communicate with one or more core networks via a Radio Access Network (RAN). The terminal 11 may be an Internet of Things terminal, such as a sensor device, a mobile phone (or “cellular” phone) and a computer with an Internet of Things terminal. For example, it may be a fixed, portable, pocket-sized, handheld, computer-built-in or vehicle-mounted apparatus, such as a station (STA), a subscriber unit, a subscriber station, a mobile station, a mobile, a remote station, an access point, a remote terminal, an access terminal, a user apparatus (user terminal), a user agent, a user device, or a user equipment (UE). Alternatively, the terminal 11 may be a device of an unmanned aerial vehicle. Alternatively, the terminal 11 may also be a vehicle-mounted device, for example, it may be an on-board computer with a wireless communication function, or a wireless communication device externally connected to an on-board computer. Alternatively, the terminal 11 may also be a roadside device, for example, it may be a streetlight, a signal light or other roadside device with wireless communication function.

The base station 12 may be a network-side device in the wireless communication system. The wireless communication system may be the 4th generation mobile communication (4G) system, also known as the Long Term Evolution (LTE) system; or the wireless communication system may also be a 5G system, also called new radio (NR) system or 5G NR system. Alternatively, the wireless communication system may also be a next-generation system of the 5G system. The access network in the 5G system may be called a New Generation-Radio Access Network (NG-RAN). Or, it may be an MTC system.

The base station 12 may be an evolved base station (eNB) adopted in the 4G system. Alternatively, the base station 12 may also be a base station (gNB) using a centralized and distributed architecture in the 5G system. When the base station 12 adopts the centralized and distributed architecture, it usually includes a central unit (CU) and at least two distributed units (DUs). The central unit is provided with protocol stacks of the Packet Data Convergence Protocol (PDCP) layer, the radio link layer control protocol (Radio Link Control, RLC) layer, and the Media Access Control (MAC) layer; and the distributed unit is provided with a protocol stack of physical (PHY) layer, and the embodiments of the present disclosure do not limit the specific implementation of the base station 12.

A wireless connection can be established between the base station 12 and the terminal 11 through a wireless air interface. In different implementations, the wireless air interface is a wireless air interface based on the fourth generation mobile communication network technology (4G) standard; or the wireless air interface is a wireless air interface based on the fifth generation mobile communication network technology (5G) standard, for example, the wireless air interface is a new air interface; alternatively, the wireless air interface may also be a wireless air interface based on the next generation mobile communication network technology standard of 5G.

In some embodiments, an End to End (E2E) connection can also be established between the terminals 11, for example, vehicle to vehicle (V2V) communication, vehicle to infrastructure (V2I) communication and vehicle to pedestrian (V2P) communication in vehicle to everything (V2X), and other scenarios.

In some embodiments, the above-mentioned wireless communication system may also include a network management device 13.

Several base stations 12 are connected to the network management device 13 respectively. The network management device 13 may be a core network device in the wireless communication system. For example, the network management device 13 may be a mobility management entity (MME) in an evolved packet core network device (Evolved Packet Core, EPC). Alternatively, the network management device may also be other core network devices, such as a serving gateway (SGW), a public data network gateway (PGW), a policy and charging rules functional unit (Policy and Charging Rules Function, PCRF) or a Home Subscriber Server (HSS), etc. The embodiments of the present disclosure do not limit the implementation form of the network management device 13.

PINE cannot directly access cellular mobile communication networks, such as 5GS networks. How to enable PINE to directly access the cellular mobile communication network is a problem that needs to be solved urgently.

As shown in FIG. 2, this exemplary embodiment provides an authentication method that can be performed by the core network device of the cellular mobile communication system, including the following steps.

In step 201: an identity authentication is performed on a PINE, where the PINE accesses a first type network through a PEGC, and the PINE and the PEGC are connected through a second type network.

In one embodiment, the first type network includes: the Third Generation Partnership Project (3GPP) standard network;
the second type network includes: a non-3GPP standard network.

Here, the first type network may be a cellular mobile communication network that complies with the 3GPP standard, such as a 5GS network, etc. The second type network may be a non-3GPP standard network, and the second type network includes but is not limited to at least one of the following: Wi-Fi network, Bluetooth network, ZigBee, etc.

Here, PINE may be a communication device in the Internet of Things that cannot directly access the first type network (such as 5GS and other cellular mobile communication networks). For example, PINE may be wearable devices, smart home appliances, smart office equipment, etc. The PEGC may be a communication device that can directly access the first type network (such as the cellular mobile communication network). PEGC may have access capabilities to both the first type network and the second type network. PEGC can provide a gateway service for accessing the first type network (such as the cellular mobile communication network) for the communication device (such as PINE) that cannot directly access the first type network. PEGC and the communication device that cannot directly access the first type network can be connected through the second type network.

In one embodiment, the PEGC includes a user equipment (UE).

The PEGC may be a UE with access capabilities to both the first type network and the second type network. For example, PEGC may be a terminal device, such as a mobile phone.

PINE may access 5GS through PEGC, and 5GS needs to identify the PINE for enhanced management. For example, 5GS needs to determine the quality of service (QoS) for different PINEs. Therefore, the identity authentication of PINE can be performed by the core network device.

Here, the identity authentication of PINE can be performed by the core network device. PINE and the core network device can mutually transmit authentication information that needs to be transmitted during the authentication procedure through PEGC. The authentication information here can include: a PINE identifier, a root key, etc.

After the core network device performs the identity authentication on the PINE, it can implement management that complies with 3GPP requirements for the PINE. For example, it can adopt a corresponding QoS, security policy, etc. with respect to data transmission of the PINE.

In this way, the identity authentication of PINE by the core network device can enable PINE to directly access the cellular mobile communication network. The communication of PINE in the first type network can be managed by the core network device, which satisfies the requirement of the core network device for managing the device that accesses the first type network, meets the data transmission requirement of PINE, and improves data transmission reliability.

In a possible implementation, the cellular mobile communication network needs to provide a credential for PINE. Using the credential, the cellular mobile communication network can authenticate and identify the PINE connected to the PEGC.

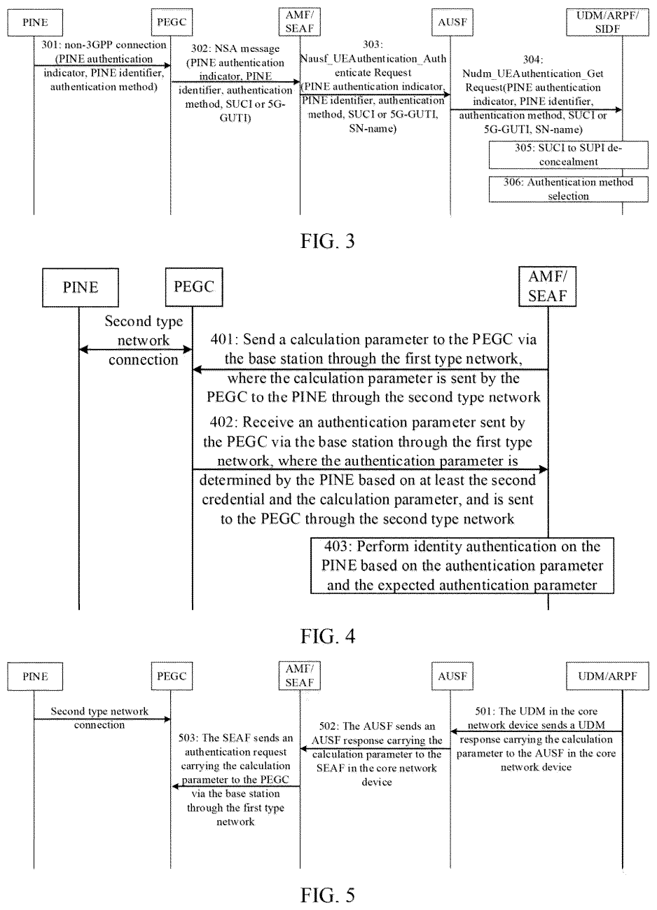

In a possible implementation, the identity authentication of PINE can be triggered by PINE, PEGC and/or the core network device. The method for triggering the identity authentication for PINE, as shown in FIG. 3, can include the following steps.

In step 301: the PINE sends its PINE identifier (i.e., a device identifier of PINE) to the PEGC, and also sends the authentication method and the PINE authentication indicator via a non-3GPP connection (the second type network). The non-3GPP connection (the second type network) established between PINE and PEGC may be a secure connection. How to establish a non-3GPP secure link is not limited here.

In step 302: the PEGC sends the PINE authentication indicator, the PINE identifier, the authentication method, SUCI or 5G-GUTI of PEGC to the AMF/SEAF network element in the core network device via the NAS message.

In step 303: whenever the AMF wishes to initiate PINE, AMF may invoke the Nausf_UEAuthentication service by sending a Nausf_UEAuthentication_Authenticate Request message to the AUSF. The Nausf_UEAuthentication_AuthenticateRequest message may contain the PINE authentication indicator, the PINE identifier, the authentication method, and a service network identifier (Service Network Name, SN-Name).

In step 304: after the AUSF receives the Nausf_UEAuthentication_AuthenticateRequest message, the AUSF may check whether the requesting AMF in the serving network is entitled to use the service network identifier in the Nausf_UEAuthentication_Authenticate Request by comparing the service network identifier (SN-Name) with the expected service network identifier (SN-Name). The AUSF may store the received service network identifier temporarily. If the serving network is not authorized to use the service network identifier, the AUSF may respond with “serving network not authorized” in the Nausf_UEAuthentication_AuthenticateResponse. If the serving network is authorized to use the service network identifier, the AUSF sends a Nudm_UEAuthentication_GetRequest message to the UDM. The Nudm_UEAuthentication_GetRequest message may include: the PINE authentication indicator, the PINE identifier, the SUPI or SUCI of PEGC, the authentication method, and the service network identifier.

In step 305: after receiving the Nudm_UEAuthentication_Get Request, if the UDM receives SUCI, the UDM may invoke a subscription identifier de-concealing function (SIDF) to decrypt the SUCI and obtain SUPI.

In step 306: the UDM/ARPF allows the PEGC to perform the authentication procedure for the PINE according to the SUPI of the PEGC and the device identifier and according to subscription verification of the PEGC, and then chooses the authentication method for the PINE based on the PINE identifier and the authentication method sent by the PINE.

In the above method, the PINE can locally store the credential provided by the home network of PEGC, that is, the second type network. And the PINE identifier of PINE may be linked with the subscription information of PEGC. PEGC may be a gateway that has registered to the 5GC, and the connection between PEGC and AMF is protected by the NAS security. AMF and SEAF are collocated.

In one embodiment, performing the identity authentication on PINE includes:
determining an expected authentication parameter based on at least a first credential and a calculation parameter of the PINE;
based on the expected authentication parameter, performing the identity authentication on the PINE.

In this embodiment, the expected authentication parameter may be represented by XRES*, the authentication parameter may be represented by RES*, the hash expected authentication parameter may be represented by HXRES*, and the hash authentication parameter may be represented by HRES*.

The PINE credential configured for PINE by the first network may include: a first credential stored in the core network device and a second credential stored in PINE. For the same PINE, the first credential is equal to the second credential. The PINE credentials may be used as the root key for the identity authentication of PINE.

In a possible implementation, it may be configured by the first network for PINE. Different PINE credentials may correspond to different PINEs.

In one embodiment, the first credential is stored in the core network device.

In a possible implementation, the first credential is stored in the UDM.

In one embodiment, the first credential is determined by the core network device according to a PINE identifier of the PINE and/or a PEGC identifier of the PEGC.

In a possible implementation, the first credential may correspond to the PINE identifier of PINE. Here, the PINE identifier may include a protected PINE identifier, or a plaintext PINE identifier. The protected PINE identifier may include one of the following: an anonymized PINE identifier; an encrypted PINE identifier.

In a possible implementation, the first credential may correspond to the PINE identifier of PINE and/or the PEGC identifier of PEGC of PINE. The PINE identifier may uniquely identify PINE. The PEGC identifier may uniquely identify PEGC.

The core network device may determine the first credential corresponding to the PINE based on the PINE identifier of the PINE and/or the PEGC identifier. Here, the PINE identifier may be carried by trigger information that triggers the core network device to perform PINE authentication. For example, the trigger information may be Nudm_UEAuthentication_Get Request, etc.

The core network device may determine XRES* based on at least the first credential and the calculation parameter.

The calculation parameter may be at least one parameter used in the calculation of XRES*. Here, the calculation method used by the core network device to determine XRES* can be the same as the calculation method used by PINE to determine RES*.

In one embodiment, the calculation parameter includes at least a random number RAND.

The calculation parameter may be a random number used to calculate XRES*.

In one embodiment, determining the expected authentication parameter based on at least the first credential and the calculation parameter of the PINE includes:

determining the expected authentication parameter based on at least the first credential, the calculation parameter and the service network identifier;
the RES* is determined by the PINE based on at least the second credential, the calculation parameter and the service network identifier.

For example, the core network device may determine XRES* based on a predetermined calculation method and at least one of the following:

$$FC = 0 x 6 B ;$$

$$P 0 = SN - Name service network identifier ;$$

$$L 0 = a length of the service network identifier ;$$

$$P 1 = the calculation parameter , i . e . RAND ;$$

$$L 1 = a length of RAND ( such as : 0 x 00 , 0 x 10 ) ;$$

$$P 2 = XRES ;$$

$$L 2 = a length of XRES ( such as the following variable lengths : 0 x 00 \; 0 x 04 and 0 x 00 \; 0 x 10 ) .$$

The core network device can send the calculation parameter and/or SN-Name to PINE, and PINE determines RES* in combination with the stored second credential. PINE can determine RES* based on the above-mentioned similar method, which will not be described again here.

In one embodiment, the first credential is determined by the UDM in the core network device according to the PINE identifier of the PINE and/or the PEGC identifier of the PEGC.

Trigger information that triggers authentication of PINE can be sent to UDM. The UDM may determine the first credential of the PINE based on the PINE identifier and/or the PEGC identifier of the PEGC.

The first credential may be stored in UDM, and XRES* may be determined by UDM, thereby initiating identity authentication for PINE.

XRES* may be used to be compared with the RES* calculated by PINE to confirm whether the second credential of PINE is the same as the first credential in UDM, thereby determining the identity of PINE and completing the identity authentication of the PINE. UDM may include authentication credential repository and processing function (ARPF).

Illustratively, for each Nudm_Authenticate_Get Request shown in FIG. 3, UDM/ARPF creates a 5G HE AV for PINE according to the locally stored PINE credential, that is, the first credential. UDM/ARPF achieves this by generating an AV with the Authentication Management Field (AMF) separation bit set to “1”. UDM/ARPF can then calculate XRES*. UDM/ARPF can create a 5G HE AV, and the 5G HE AV can include: RAND, authentication token AUTN, and XRES*.

In one embodiment, the method further includes: determining whether the PEGC is a legal gateway for the PEGC to access the first type network based on judgment information, where the judgment information includes at least one of the following:
a PEGC identifier of the PEGC;
a PINE identifier of the PINE;
subscription information of the PEGC;
determining the expected authentication parameter based on at least the first credential and the calculation parameter of the PINE, includes:
determining that the PEGC is the legal gateway;
determining the expected authentication parameter based on the first credential and the calculation parameter of the PINE.

Before UDM determines XRES*, UDM can also determine whether PEGC is a legal gateway of PINE: first, UDM can determine whether PEGC is a legal gateway in the first type network based on the judgment information. For example, UDM can make judgments based on the PEGC identifier. Then UDM can determine whether PEGC is a legal gateway of PINE. For example, it can determine whether PEGC is allowed to make PINE access the first type network. The UDM may make a determination based on the PEGC identifier, the PINE identifier of the PINE, and the subscription information of PEGC. For example, when the subscription information of PEGC identified by the PEGC identifier has the PINE identifier of PINE, the PEGC is determined to be the legal gateway of PINE.

The PEGC identifier may include: user concealed identifier (Subscriptionconcealed Identifier, SUCI) and/or user permanent identifier (Subscription Permanent Identifier, SUPI).

In one embodiment, performing the identity authentication on the PINE based on the expected authentication parameter, as shown in FIG. 4, may include the following steps.

In step 401: a calculation parameter is sent to the PEGC via the base station through the first type network, where the calculation parameter is sent by the PEGC to the PINE through the second type network.

In step 402: an authentication parameter sent by the PEGC via the base station through the first type network is received, where the authentication parameter is determined by the PINE based on at least the second credential and the calculation parameter, and is sent to the PEGC through the second type network.

In step 403: identity authentication is performed on the PINE based on the authentication parameter and the expected authentication parameter.

After determining XRES*, the core network device can send the calculation parameter to PEGC of PINE through the second type network. Here, the calculation parameter can be sent by PEGC to PINE, and PINE determines RES* based on the second credential, the calculation parameter, etc. The second credential may be determined by the first network, for example, it may be determined by the core network device of the first network. It can be sent by the first network to PINE via PEGC.

The core network device can determine whether the identity authentication of PINE is successful based on the comparison result of RES* and XRES*.

If the first credential is the same as the second credential, then the RES* and XRES* determined based on the same calculation parameter is also the same, then the identity authentication of PINE is successful.

If the first credential and the second credential are not the same, then the RES* and XRES* determined based on the same calculation parameter are also different, and the identity authentication of PINE fails.

In a possible implementation, performing identity authentication on the PINE based on the RES* and the expected authentication parameter may also include:
performing identity authentication on the PINE based on the HRES* determined according to the RES* and the HRES* determined according to the expected authentication parameter.

In one embodiment, step 401, as shown in FIG. 5, may include the following steps.

In step 501: the UDM in the core network device sends a UDM response carrying the calculation parameter to the AUSF in the core network device.

In step 502: the AUSF sends an AUSF response carrying the calculation parameter to the SEAF in the core network device.

In step 503: the SEAF sends an authentication request carrying the calculation parameter to the PEGC via the base station through the first type network.

UDM can carry the calculation parameter (such as RAND) in the UDM response and send it to AUSF. The UDM response may be Nudm_UEAuthentication_Get Response. For example, UDM can return 5G HE AV to AUSF in Nudm_UEAuthentication_Get Response, 5G HE AV can include: RAND, AUTN and XRES*. The UDM response may carry the PINE authentication indicator indicating identity authentication of the PINE. AUSF may determine the UDM response for authentication to PINE based on the PINE authentication indicator.

If the PINE identifier and the SUCI of PEGC are included in Nudm_UEAuthentication_Get Request, UDM includes the PINE identifier and the SUPI of PEGC in Nudm_UEAuthentication_Get Response after SIDF de-conceals the SUCI.

AUSF can store XRES*, PINE identifier and SUPI. Then, AUSF can calculate HXRES* from XRES*. AUSF can generate 5G AV according to the 5G HE AV received from UDM/ARPF and replace XRES* with HXRES*. 5G HE AV can include: RAND, AUTN, HXRES*.

AUSF can return 5G SE AV (RAND, AUTN, HXRES*), PINE authentication indicator, SUPI of PEGC, and PINE identifier to SEAF in the AUSF response (such as Nausf_UEAuthentication_Authenticate Response). SEAF can store received HXRES*.

SEAF can send the PINE authentication indicator, RAND, AUTN, and PINE identifier to PEGC in the authentication request (such as NAS message). The authentication request can be an Authentication Request.

In one embodiment, the calculation parameter and/or the service network identifier are sent by the PEGC to the PINE through the second type network.

PEGC may forward the SN-name, RAND, AUTN and PINE authentication indicator received in the authentication request to PINE through the secure non-3GPP second network. PEGC may carry the calculation parameter and/or the SN-Name in the PINE authentication request.

After the PINE receives the RAND, AUTN and SN-Name carried in the PINE authentication request, the PINE may determine whether it can accept the PINE authentication request by checking the AUTN. For example, PINE may verify the freshness of the received AUTN. If the PINE determines that the PINE authentication request is acceptable, then the PINE may calculate RES*. For example, PINE may first calculate RES, CK, and IK, and then PINE ME may calculate RES* from RES.

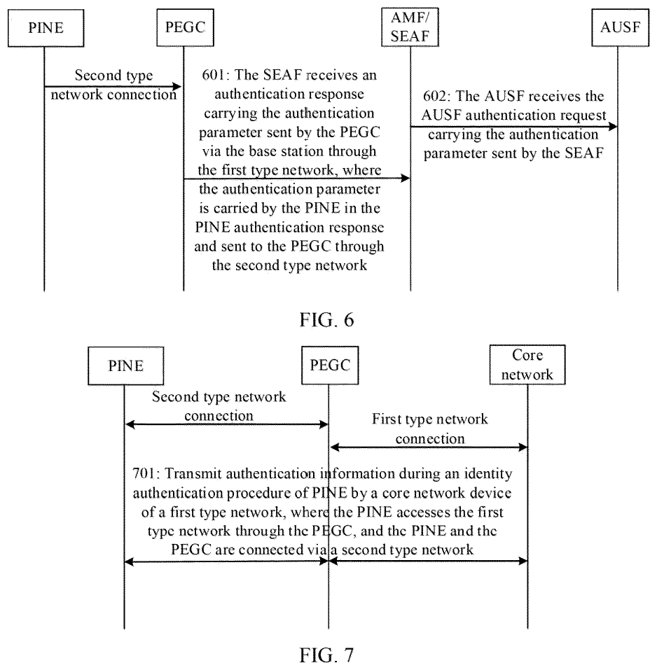

In one embodiment, step 402, as shown in FIG. 6, may include the following steps.

In step 601: the SEAF receives an authentication response carrying the authentication parameter sent by the PEGC via the base station through the first type network, where the authentication parameter is carried by the PINE in the PINE authentication response and sent to the PEGC through the second type network.

In step 602: the AUSF receives the AUSF authentication request carrying the authentication parameter sent by the SEAF.

After PINE determines RES*, it can send RES* to the core network device.

PINE can return a PINE authentication response to PEGC through a secure non-3GPP second type network. The PINE authentication response can include: RES*, PINE identifier and PINE authentication indicator. The PINE authentication response can be a PINE Authentication Response.

PEGC may send an authentication response to SEAF in a NAS message, where the authentication response may include: RES*, PINE identifier and PINE authentication indicator. The authentication response can be: Authentication Response.

SEAF can send RES*, PINE identifier, PINE authentication indicator and SUPI of PEGC to AUSF in the AUSF authentication request (Nausf_UEAuthentication_Authenticate Request).

In one embodiment, performing the identity authentication on the PINE based on the authentication parameter and the expected authentication parameter includes at least one of the following:
the SEAF determining a hash authentication parameter based on the authentication parameter, and performing identity authentication on the PINE based on the hash authentication parameter and a hash expected authentication parameter, where the hash expected authentication parameter is determined by the AUSF based on the expected authentication parameter and sent to SEAF;
the AUSF performing identity authentication on the PINE based on the authentication parameter and the expected authentication parameter.

SEAF can calculate HRES* through RES*, and SEAF can compare HRES* with HXRES*. For example, SEAF may locate HXRES* of PINE based on the PINE identifier and/or SUPI of PEGC. If they coincide, SEAF will consider the authentication as successful from the serving network point of view. If not, SEAF can determine that authentication was not successful. If the SEAF never receives the RES*, the SEAF considers the authentication to have failed and indicate to the AUSF that the identity authentication of PINE failed.

When AUSF receives the AUSF authentication request (Nausf_UEAuthentication_Authenticate Request message) including RES* as the identity authentication confirmation, it can verify whether the 5G AV has expired. If the 5G AV has expired, AUSF may consider the PINE identity authentication unsuccessful. AUSF compares the received RES* with the stored XRES*, If the RES* and the XRES* are equal, the AUSF considers the authentication successful from the home network point of view. AUSF notifies UDM of the authentication result.

In a possible implementation, the AUSF can indicate to the SEAF whether the identity authentication of PINE is successful from the home network point of view in the AUSF authentication response (Nausf_UEAuthentication_Authenticate Response).

In a possible implementation. SEAF can determine HRES* according to RES*, and AUSF can determine HXRES* according to XRES*. SEAF and AUSF can determine HRES* and HXRES* respectively using the SHA-256 hash algorithm. The parameter used by the SHA-256 hash algorithm includes but is not limited to:

$$P 0 = calculation parameter ( such as RAND ) ;$$

$$P 1 = RES * or XRES * ,$$

input S is equal to the series concatenation of P0 and P1; P0∥P1. HRES* and HXRES* are identified by the 128 least significant bits output by the SHA-256 function.

In one embodiment, the authentication parameter, the expected authentication parameter, the hash authentication parameter and the hash expected authentication parameter are identified by at least one of the following:
a PINE identifier of the PINE;
a PEGC identifier of the PEGC.

In a possible implementation, RES*, XRES*, HRES*, and HXRES* may have a PINE identifier that indicates the corresponding PINE, and/or a PEGC identifier that indicates the corresponding PEGC. When the core network device stores RES*, XRES*, HRES*, and/or HXRES*, it may use the PINE identifier and/or the PEGC identifier for identification. For example, SEAF may use the PINE identifier when storing XRES* and HXRES*.

In a possible implementation, during the transmission process of RES*, XRES*, HRES* and/or HXRES*, the PINE identifier and/or PEGC identifier carried in the transmission message can be used for identification. The transmission message may include at least one of the following: the UDM response, the AUSF response, the authentication request, the authentication response, the PINE authentication request, the PINE authentication response, and the AUSF authentication request.

In one embodiment, at least one of the UDM response, the AUSF response, the authentication request, the authentication response, the PINE authentication request, the PINE authentication response and the AUSF authentication request carries at least one of the following:
a PINE authentication indicator, used to indicate to perform identity authentication on the PINE;
a subscription permanent identifier (SUPI), used to indicate the PEGC.

Here, the PINE authentication indicator can indicate to the core network device (such as UDM, AUSF, SEAF), PEGC, and PINE that the received message is used for identity authentication of PINE.

SUPI can indicate to the core network device (such as UDM, AUSF, SEAF), PEGC, and PINE, the PEGC connected to the PINE on which identity authentication is performed. The core network device and/or PINE may send corresponding information to the PEGC indicated by SUPT.

In one embodiment, at least one of the UDM response, the AUSF response, the authentication request, the PINE authentication request, the PINE authentication response, the authentication response and the AUSF authentication request carries the PINE identifier indicating the PINE.

Here, the PINE authentication indicator can indicate to the core network device and PEGC the PINE on which identity authentication is performed.

In one embodiment, the PINE identifier is a security-protected PINE identifier.

The security-protected PINE identifier may include an encrypted PINE identifier, an anonymous PINE identifier, etc.

In a possible implementation, at least one of the UDM response, the AUSF response, the authentication request, the PINE authentication request, the PINE authentication response, the authentication response and the AUSF authentication request carries the security-protected PINE identifier.

In one embodiment, the method further includes: in response to the PINE identifier being a security-protected PINE identifier, restoring the security-protected PINE identifier to a PINE identifier in a plaintext state;
at least one of the UDM response, the AUSF response and the AUSF authentication request carries the PINE identifier in the plaintext state;
at least one of the authentication request, the PINE authentication request, the PINE authentication response, and the authentication response carries the security-protected PINE identifier.

When the PINE identifier received by the core network device network element (such as UDM) is a protected PINE identifier, it needs to convert the protected PINE identifier into a PINE identifier in a plaintext state through deanonymization, decryption, etc.

When the core network device transmits within the core network device, the PINE identifier in the plaintext state can be used. For example, at least one of the authentication request, the PINE authentication request, the PINE authentication response, and the authentication response carries the security-protected PINE identifier.

When the PINE identifier is transmitted outside the core network device, the protected PINE identifier can be used. That is, in the communications among SEAF-PEGC-PINE, a protected PINE identifier is used, for example, at least one of the authentication request, the PINE authentication request, the PINE authentication response and the authentication response carries the security-protected PINE identifier.

In a possible implementation, if the PINE identifier received by UDM is unprotected information (that is, the PINE identifier in the plaintext state), in the communication among SEAF-PEGC-PINE, unprotected information (PINE identifier in the plaintext state) is used. For example, at least one of the authentication request, the PINE authentication request, the PINE authentication response, and the authentication response carries a PINE identifier in the plaintext state.

In one embodiment, the PINE authentication indicator is used to indicate that the core network device does not perform at least one of the following:
generating an authentication service function key Kausf;
generating a security anchor function key Kseaf;
sending a key set identifier ngKSI to the PEGC;
sending an anti-bidding down between architectures (ABBA) parameter to the PEGC.

In related art, UDM needs to determine the Kausf during the identity authentication procedure. Here, during the PINE identity authentication procedure, it is unnecessary for the UDM to determine Kausf and the UDM no longer transmits Kausf, thus reducing the load of the core network device. The authentication service function key Kausf generates a security anchor function key Kseaf.

In related art, AUSF needs to determine Kseaf during the identity authentication procedure. Here, during the PINE identity authentication procedure, AUSF needs not to determine Kseaf and no longer transmit Kseaf, thereby reducing the load of the core network device. The key set identifier ngKSI is the identifier of the key set used by the UE in the first type network, and is used to indicate that the first type network uses the same key set as the UE. The ABBA parameter is used by the AMF network element to generate KAMF. The key set identifier (ngKSI, key setidentifier in 5G) may be used to create a local security context after successful authentication, and the anti-bidding down between architectures (ABBA) parameter may be used to differentiate version security feature indication parameters to prevent confusion.

PINE accesses the first type network through PEGC. Therefore, SEAF can no longer determine the ngKSI and ABBA parameters and no longer transmit them, thereby reducing the load of the core network device.

As shown in FIG. 7, this exemplary embodiment provides an authentication method that can be performed by the PIN element with gateway capability (PEGC) of the cellular mobile communication system. The method includes the following steps.

In step 701: authentication information is transmitted during an identity authentication procedure of PINE by a core network device of a first type network, where the PINE accesses the first type network through the PEGC, and the PINE and the PEGC are connected via a second type network.

In one embodiment, the first type network includes: the Third Generation Partnership Project (3GPP) standard network;
the second type network includes: a non-3GPP standard network.

Here, the first type network may be a cellular mobile communication network that complies with 3GPP standards, such as a 5GS network, etc. The second type network may be a non-3GPP standard network, and the second type network includes but is not limited to at least one of the following: Wi-Fi network, Bluetooth network, ZigBee, etc.

Here, PINE may be a communication device in the Internet of Things that cannot directly access the first type network (such as 5GS and other cellular mobile communication networks). For example, PINE may be wearable devices, smart home appliances, smart office equipment, etc. The PEGC may be a communication device that can directly access the first type network (such as the cellular mobile communication network). PEGC may have access capabilities to both the first type network and the second type network. PEGC can provide a gateway service for accessing the first type network (such as the cellular mobile communication network) for the communication device (such as PINE) that cannot directly access the first type network. PEGC and the communication device that cannot directly access the first type network can be connected through the second type network.

In one embodiment, the PEGC includes a user equipment (UE).

The PEGC may be a UE with access capabilities to both the first type network and the second type network. For example, PEGC may be a terminal device, such as a mobile phone.

PINE may access 5GS through PEGC, and 5GS needs to identify the PINE for enhanced management. For example, 5GS needs to determine the quality of service for different PINEs. Therefore, the identity authentication of PINE can be performed by the core network device.

Here, the identity authentication of PINE can be performed by the core network device. PINE and the core network device can mutually transmit authentication information that needs to be transmitted during the authentication process through PEGC. The authentication information here can include: a PINE identifier, a root key, etc.

After the core network device performs the identity authentication on the PINE, it can implement management that complies with 3GPP requirements for the PINE. For example, corresponding QoS, security policies, etc., can be adopted for data transmission of PINE.

In this way, the identity authentication of PINE by the core network device can enable PINE to directly access the cellular mobile communication network. The communication of PINE in the first type network can be managed by the core network device, which satisfies the requirement of the core network device for managing the device that accesses the first type network, meets the data transmission requirement of PINE, and improves data transmission reliability.

In one embodiment, transmitting the information during the identity authentication procedure of PINE by the core network device of the first type network includes:
receiving a calculation parameter sent by the core network device to the PEGC via a base station through the first type network; where the calculation parameter is used to determine an expected authentication parameter by the core network device in combination with at least the first credential, and the expected authentication parameter is used for the core network device to perform identity authentication on the PINE.

In this embodiment, the expected authentication parameter may be represented by XRES*, the authentication parameter may be represented by RES*, the hash expected authentication parameter may be represented by HXRES*, and the hash authentication parameter may be represented by HRES*.

The PINE credential configured for PINE by the first network may include: a first credential stored in the core network device and a second credential stored in PINE. For the same PINE, the first credential is equal to the second credential. The PINE credentials may be used as the root key for identity authentication of PINE.

In a possible implementation, it may be configured by the first network for PINE. Different PINE credentials may correspond to different PINEs.

In one embodiment, the first credential is stored in the core network device.

In a possible implementation, the first credential is stored in UDM. In one embodiment, the first credential is determined by the core network device according to the PINE identifier of the PINE and/or the PEGC identifier of the PEGC.

In a possible implementation, the first credential may correspond to the PINE identifier of PINE. Here, the PINE identifier may include a protected PINE identifier, or a plaintext PINE identifier. The protected PINE identifier may include one of the following: an anonymized PINE identifier, an encrypted PINE identifier.

In a possible implementation, the first credential may correspond to the PINE identifier of PINE and/or the PEGC identifier of PEGC of PINE. The PINE identifier may uniquely identify PINE. The PEGC identifier may uniquely identify PEGC.

The core network device may determine the first credential corresponding to the PINE based on the PINE identifier and/or the PEGC identifier of the PINE. Here, the PINE identifier may be carried by trigger information that triggers the core network device to perform PINE authentication. For example, the trigger information may be Nud_UEAuthentication_Get Request, etc.

The core network device may determine XRES* based on at least the first credential and the calculation parameter.

The calculation parameter may be at least one parameter used in the calculation of XRES*. Here, the calculation method used by the core network device to determine XRES* can be the same as the calculation method used by PINE to determine RES*.

In one embodiment, the first credential is determined by the UDM in the core network device according to the PINE identifier of the PINE and/or the PEGC identifier of the PEGC.

Trigger information that triggers authentication of PINE can be sent to UDM. The UDM may determine the first credential of the PINE based on the PINE identifier and/or the PEGC identifier of the PEGC.

The first credential may be stored in UDM, and XRES* may be determined by UDM, thereby initiating identity authentication for PINE.

XRES* may be used to compare with the RES* calculated by PINE to confirm whether the second credential of PINE is the same as the first credential in UDM, thereby determining the identity of PINE and completing the identity authentication of the PINE. UDM may include authentication credential repository and processing function (ARPF).

Illustratively, for each Nudm_Authenticate_Get Request shown in FIG. 3, UDM/ARPF creates a 5G HE AV for PINE according to the locally stored PINE credential, that is, the first credential. UDM/ARPF achieves this by generating an AV with the Authentication Management Field (AMF) separation bit set to “1”. UDM/ARPF can then calculate XRES*. UDM/ARPF can create a 5G HE AV, and the 5G HE AV can include: RAND, authentication token AUTN, and XRES*.

Before UDM determines XRES*, UDM can also determine whether PEGC is a legal gateway of PINE: first, UDM can determine whether PEGC is a legal gateway in the first type network based on the judgment information. For example, UDM can make judgments based on the PEGC identifier. Then UDM can determine whether PEGC is a legal gateway of PINE. For example, it can determine whether PEGC is allowed to make PINE access the first type network. The UDM may make a determination based on the PEGC identifier, the PINE identifier of the PINE, and the subscription information of PEGC. For example, when the subscription information of PEGC identified by the PEGC identifier has the PINE identifier of PINE, the PEGC is determined to be the legal gateway of PINE.

The judgment information includes at least one of the following: the PEGC identifier of the PEGC; the PINE identifier of the PINE; and the subscription information of the PEGC. The PEGC identifier may include: a user concealed identifier (Subscriptionconcealed Identifier, SUCI) and/or a user permanent identifier (Subscription Permanent Identifier, SUPI).

In one embodiment, the calculation parameter includes at least a random number RAND.

The calculation parameter can be a random number used to calculate XRES*.

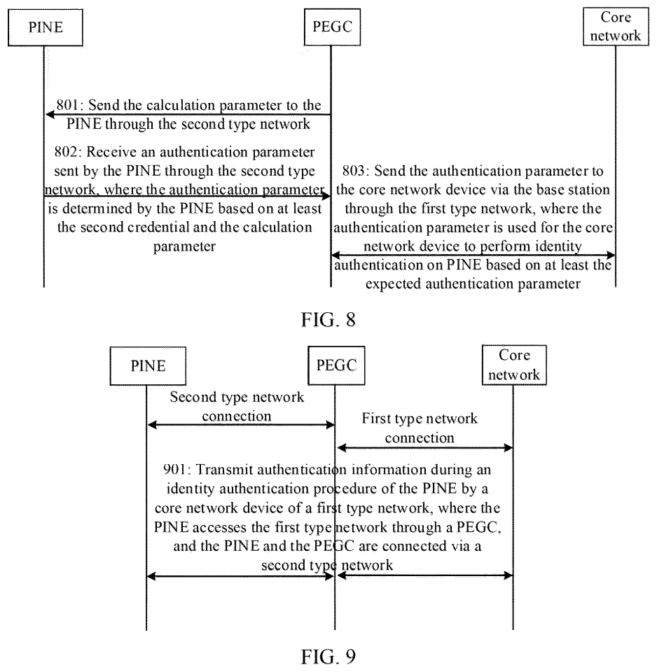

In one embodiment, as shown in FIG. 8, transmitting the information during the identity authentication procedure of PINE by the core network device of the first type network includes the following steps.

In step 801: the calculation parameter is sent to the PINE through the second type network.

In step 802: an authentication parameter sent by the PINE through the second type network is received, where the authentication parameter is determined by the PINE based on at least the second credential and the calculation parameter.

In step 803: the authentication parameter is sent to the core network device via the base station through the first type network, where the authentication parameter is used for the core network device to perform identity authentication on PINE based on at least the expected authentication parameter.

After determining XRES*, the core network device can send the calculation parameter to PEGC of PINE through the second type network. Here, the calculation parameter can be sent by PEGC to PINE, and PINE determines RES* based on the second credential, the calculation parameter, etc. The second credential may be determined by the first network, for example, it may be determined by the core network device of the first network. It can be sent by the first network to PINE via PEGC.

The core network device can determine whether the identity authentication of PINE is successful based on the comparison result of RES* and XRES*.

If the first credential is the same as the second credential, then the RES* and XRES* determined based on the same calculation parameter is also the same, then the identity authentication of PINE is successful.

If the first credential and the second credential are not the same, then the RES* and XRES* determined based on the same calculation parameter are also different, and the identity authentication of PINE fails.

In a possible implementation, performing identity authentication on the PINE based on the RES* and the XRES* may also include:
performing identity authentication on the PINE based on the HRES* determined according to RES* and the HRES* determined according to XRES*.

In one embodiment, receiving the calculation parameter sent by the core network device to the PEGC via the base station through the first type network include:
receiving an authentication request carrying the calculation parameter sent by a SEAF in the core network device via the base station through the first type network;
sending the calculation parameter to the PINE through the second type network includes:
sending a PINE authentication request carrying the calculation parameter to the PINE through the second type network;
receiving the authentication parameter sent by the PINE through the second type network includes:
receiving a PINE authentication response carrying the authentication parameter sent by the PINE through the second type network;
sending the authentication parameter to the core network device via the base station through the first type network includes:
sending an authentication response carrying the authentication parameter to the SEAF via the base station through the first type network.

UDM can carry the calculation parameter (such as RAND) in the UDM response and send it to AUSF. The UDM response may be Nudm_UEAuthentication_Get Response. For example, UDM can return 5G HE AV to AUSF in Nudm_UEAuthentication_Get Response. 5G HE AV can include: RAND, AUTN and XRES*. The UDM response may carry a PINE authentication indicator indicating identity authentication of the PINE. AUSF may determine that the UDM response is used for authentication of PINE based on the PINE authentication indicator.

If the PINE identifier and SUCI of PEGC are included in Nudm_UEAuthentication_Get Request, UDM includes the PINE identifier and the SUPI of PEGC in Nudm_UEAuthentication_Get Response after deconcealment of SUCI by SIDF.

AUSF can store XRES*, PINE identifier and SUPI. Then, AUSF can calculate HXRES* from XRES*. AUSF can generate 5G AV according to the 5G HE AV received from UDM/ARPF and replace XRES* with HXRES*. 5G HE AV can include: RAND, AUTN, HXRES*.

AUSF can return 5G SE AV (RAND, AUTN, HXRES*), PINE authentication indicator, SUPI of PEGC, and PINE identifier to SEAF in the AUSF response (such as Nausf_UEAuthentication_Authenticate Response). SEAF can store received HXRES*.

SEAF can send the PINE authentication indicator, RAND, AUTN, and PINE identifier to PEGC in the authentication request (such as NAS message). The authentication request can be an Authentication Request.

In one embodiment, the PINE authentication request also carries a service network identifier.

PEGC may forward the SN-name. RAND, AUTN and PINE authentication indicator received in the authentication request to PINE through the secure non-3GPP second network. PEGC may carry the calculation parameter and/or the SN-Name in the PINE authentication request.

After PINE receives the RAND, AUTN and SN-Name carried in the PINE authentication request, PINE can determine whether it can accept the PINE authentication request by checking the AUTN. For example, PINE can verify the freshness of received AUTN. If PINE determines that the PINE authentication request is acceptable, then PINE may calculate RES*. For example, PINE can first calculate RES, CK, and IK, and then PINE ME can calculate RES* from RES.

After PINE determines RES*, it can send RES* to the core network device.

PINE can return a PINE authentication response to PEGC through a secure non-3GPP second type network. The PINE authentication response can include: RES*, PINE identifier and PINE authentication indicator. The PINE authentication response may be PINE Authentication Response.

PEGC may send an authentication response to SEAF in a NAS message, where the authentication response may include: RES*, PINE identifier and PINE authentication indicator. The authentication response may be: Authentication Response.

SEAF can send RES*, PINE identifier, PINE authentication indicator and SUPI of PEGC to AUSF in the A USF authentication request (Nausf_UEAuthentication_Authenticate Request).

In one embodiment, the expected authentication parameter is determined by the core network device based on at least the first credential, the calculation parameter and the service network identifier;
the authentication parameter is determined by the PINE based on at least the second credential, the calculation parameter and the service network identifier.

For example, the core network device may determine XRES* based on a predetermined calculation method and at least one of the following:

$$FC = 0 x 6 B ;$$

$$P 0 = SN - Name service network identifier ;$$

$$L 0 = length of service network identifier ;$$

$$P 1 = calculation parameter , i . e . RAND ;$$

$$L 1 = length of RAND ( such as : 0 x 00 , 0 x 10 ) ;$$

$$P 2 = XRES ;$$

$$L 2 = length of XRES ( such as the following variable lengths : 0 x 00 \; 0 x 04 and 0 x 00 \; 0 x 10 ) .$$

The core network device can send the calculation parameter and/or SN-Name to PINE, and PINE determines RES* in combination with the stored second credential. PINE can determine RES* based on the above-mentioned similar method, which will not be described again here.

SEAF can calculate HRES* through RES*, and SEAF can compare HRES* with HXRES*. For example, SEAF may locate HXRES* of PINE based on the PINE identifier and/or SUPI of PEGC. If they coincide, SEAF will consider the authentication as successful from the serving network point of view. If not, SEAF can determine that authentication was not successful. If the SEAF never receives the RES*, the SEAF considers the authentication to have failed and indicate to the AUSF that the identity authentication of PINE failed.

When AUSF receives the AUSF authentication request (Nausf_UEAuthentication_Authenticate Request message) including RES* as the authentication confirmation, it can verify whether the 5G AV has expired. If the 5G AV has expired, AUSF may consider the PINE identity authentication unsuccessful. AUSF compares the received RES* with the stored XRES*. If the RES* and the XRES* are equal, the AUSF considers the authentication successful from the home network point of view. AUSF notifies UDM of the authentication result.

In a possible implementation, the AUSF can indicate to the SEAF whether the identity authentication of PINE is successful from the home network point of view in the AUSF authentication response (Nausf_UEAuthentication_Authenticate Response).

In a possible implementation, SEAF can determine HRES* according to RES*, and AUSF can determine HXRES* according to XRES*. SEAF and AUSF can determine HRES* and HXRES* respectively using the SHA-256 hash algorithm. The parameter used by the SHA-256 hash algorithm includes but is not limited to:

$$P 0 = calculation parameter ( such as RAND ) ;$$

$$P 1 = RES * or XRES * ,$$

input S is equal to the series concatenation of P0 and P1: P0∥P1. HRES* and HXRES* are identified by the 128 least significant bits output by the SHA-256 function.

In one embodiment, the authentication parameter, the expected authentication parameter, the hash authentication parameter and the hash expected authentication parameter are identified by at least one of the following:
a PINE identifier of the PINE;
a PEGC identifier of the PEGC.

In a possible implementation, RES*, XRES*, HRES*, and HXRES* may have a PINE identifier that indicates the corresponding PINE, and/or a PEGC identifier that indicates the corresponding PEGC. When the core network device stores RES*, XRES*, HRES*, and/or HXRES*, it may use the PINE identifier and/or the PEGC identifier for identification. For example, SEAF may use the PINE identifier when storing XRES* and HXRES*.

In a possible implementation, during the transmission process of RES*, XRES*, HRES* and/or HXRES* the PINE identifier and/or PEGC identifier carried in the transmission message can be used for identification. The transmission message may include at least one of the following: the UDM response, the AUSF response, the authentication request, the authentication response, the PINE authentication request, the PINE authentication response, and the AUSF authentication request.

In one embodiment, at least one of the authentication request, the authentication response, the PINE authentication request and the PINE authentication response carries at least one of the following:
a PINE authentication indicator, used to indicate to perform identity authentication on the PINE;
a subscription permanent identifier (SUPI), used to indicate the PEGC.

Here, the PINE authentication indicator can indicate to the core network device (such as UDM, AUSF, SEAF), PEGC, and PINE that the received message is used for identity authentication of PINE.

SUPI can indicate to the core network device (such as UDM, AUSF, SEAF), PEGC, and PINE, the PEGC connected to the PINE on which identity authentication is performed. The core network device and/or PINE may send corresponding information to the PEGC indicated by SUPI.

In one embodiment, at least one of the authentication request, the PINE authentication request, the PINE authentication response, and the authentication response carries a PINE identifier indicating the PINE.

Here, the PINE authentication indicator can indicate to the core network device and PEGC the PINE on which identity authentication is performed.

In one embodiment, the PINE identifier is a security-protected PINE identifier.

The security-protected PINE identifier may include an encrypted PINE identifier, an anonymous PINE identifier, etc.

In a possible implementation, at least one of the UDM response, the AUSF response, the authentication request, the PINE authentication request, the PINE authentication response, the authentication response and the AUSF authentication request carries the security-protected PINE identifier.

In one embodiment, the PINE identifier is a security-protected PINE identifier.

When the PINE identifier received by the core network device network element (such as UDM) is a protected PINE identifier, it needs to convert the protected PINE identifier into a PINE identifier in a plaintext state through deanonymization, decryption, etc.

When the core network device transmits within the core network device, the PINE identifier in the plaintext state can be used. For example, at least one of the authentication request, the PINE authentication request, the PINE authentication response, and the authentication response carries the security-protected PINE identifier.

When the PINE identifier is transmitted outside the core network device, the protected PINE identifier can be used. That is, in the communications among SEAF-PEGC-PINE, a protected PINE identifier is used, for example, at least one of the authentication request, the PINE authentication request, the PINE authentication response and the authentication response carries the security-protected PINE identifier.

In a possible implementation, if the PINE identifier received by UDM is unprotected information (that is, the PINE identifier in the plaintext state), in the communication among SEAF-PEGC-PINE, unprotected information (PINE identifier in the plaintext state) is used. For example, at least one of the authentication request, the PINE authentication request, the PINE authentication response, and the authentication response carries a PINE identifier in the plaintext state.

In related art, UDM needs to determine Kausf during the identity authentication procedure. Here, during the PINE identity authentication procedure, it is unnecessary for the UDM to determine Kausf and the UDM no longer transmits Kausf, thereby reducing the load of the core network device. The authentication service function key Kausf generates security anchor function key Kseaf.

In related art, AUSF needs to determine Kseaf during the identity authentication procedure. Here, during the PINE identity authentication procedure, AUSF needs not to determine Kseaf and no longer transmit Kseaf, thereby reducing the load of the core network device. The key set identifier ngKSI is the identifier of the key set used by the UE in the first type network, and is used to indicate that the first type network uses the same key set as the UE. The ABBA parameter is used by the AMF network element to generate KAMF. The key set identifier (ngKSI, key setidentifier in 5G) may be used to create a local security context after successful authentication, and the anti-bidding down between architectures (ABBA) parameter may be used to differentiate version security feature indication parameters to prevent confusion.

PINE accesses the first type network through PEGC. Therefore. SEAF can no longer determine the ngKSI and ABBA parameters and no longer transmit them, thereby reducing the load of the core network device.

As shown in FIG. 9, this exemplary embodiment provides an authentication method that can be performed by PINE. The method includes the following steps.

In step 901: authentication information is transmitted during an identity authentication procedure of the PINE by a core network device of a first type network, where the PINE accesses the first type network through a PIN element with gateway capability (PEGC), and the PINE and the PEGC are connected via a second type network.

In one embodiment, the first type network includes: the Third Generation Partnership Project (3GPP) standard network;
the second type network includes: a non-3GPP standard network.

Here, the first type network may be a cellular mobile communication network that complies with the 3GPP standard, such as a 5GS network, etc. The second type network may be a non-3GPP standard network, and the second type network includes but is not limited to at least one of the following: Wi-Fi network, Bluetooth network, ZigBee, etc.

Here, PINE may be a communication device in the Internet of Things that cannot directly access the first type network (such as 5GS and other cellular mobile communication networks). For example, PINE may be wearable devices, smart home appliances, smart office equipment, etc. The PEGC may be a communication device that can directly access the first type network (such as the cellular mobile communication network). PEGC may have access capabilities to both the first type network and the second type network. PEGC can provide a gateway service for accessing the first type network (such as the cellular mobile communication network) for the communication device (such as PINE) that cannot directly access the first type network. PEGC and the communication device that cannot directly access the first type network can be connected through the second type network.

In one embodiment, the PEGC includes a user equipment (UE).

The PEGC may be a UE with access capabilities to both the first type network and the second type network. For example, PEGC may be a terminal device, such as a mobile phone.

PINE may access 5GS through PEGC, and 5GS needs to identify the PINE for enhanced management. For example, 5GS needs to determine the quality of service for different PINEs. Therefore, the identity authentication of PINE can be performed by the core network device.

Here, the identity authentication of PINE can be performed by the core network device. PINE and the core network device can mutually transmit authentication information that needs to be transmitted during the authentication process through PEGC. The authentication information here can include: a PINE identifier, a root key, etc.

After the core network device performs the identity authentication on the PINE, it can implement management that complies with 3GPP requirements for the PINE. For example, it can adopt a corresponding QoS, security policies, etc. with respect to data transmission of the PINE.

In this way, the identity authentication of PINE by the core network device can enable PINE to directly access the cellular mobile communication network. The communication of PINE in the first type network can be managed by the core network device, which satisfies the requirement of the core network device for managing the device that accesses the first type network, meets the data transmission requirement of PINE, and improves data transmission reliability.

In one embodiment, transmitting the authentication information during the identity authentication procedure of the PINE by the core network device of the first type network includes:
receiving a calculation parameter sent by the PEGC through the second type network, where the calculation parameter is sent by the core network device to the PEGC via the base station through the first type network, the calculation parameter is used by the core network device to determine an expected authentication parameter in combination with at least the first credential, and the expected authentication parameter is used for the core network device to perform identity authentication on the PINE.

In this embodiment, the expected authentication parameter may be represented by XRES*, the authentication parameter may be represented by RES*, the hash expected authentication parameter may be represented by HXRES*, and the hash authentication parameter may be represented by HRES*.

The PINE credential configured for PINE by the first network may include: a first credential stored in the core network device and a second credential stored in PINE. For the same PINE, the first credential is equal to the second credential. The PINE credentials may be used as the root key for identity authentication of PINE.

In a possible implementation, it may be configured by the first network for PINE. Different PINE credentials may correspond to different PINEs.

In one embodiment, the first credential is stored in the core network device.

In a possible implementation, the first credential is stored in UDM.

In one embodiment, the first credential is determined by the core network device according to the PINE identifier of the PINE and/or the PEGC identifier of the PEGC.

In a possible implementation, the first credential may correspond to the PINE identifier of PINE. Here, the PINE identifier may include a protected PINE identifier, or a plaintext PINE identifier. The protected PINE identifier may include one of the following: an anonymized PINE identifier; an encrypted PINE identifier.

In a possible implementation, the first credential may correspond to the PINE identifier of PINE and/or the PEGC identifier of PEGC of PINE. The PINE identifier may uniquely identify PINE. The PEGC identifier may uniquely identify PEGC.

The core network device may determine the first credential corresponding to the PINE based on the PINE identifier and/or the PEGC identifier of the PINE. Here, the PINE identifier may be carried by trigger information that triggers the core network device to perform PINE authentication. For example, the trigger information may be Nudm_UEAuthentication_Get Request, etc.

The core network device may determine XRES* based on at least the first credential and the calculation parameter.

The calculation parameter may be at least one parameter used in the calculation of XRES*. Here, the calculation method used by the core network device to determine XRES* can be the same as the calculation method used by PINE to determine RES*.

In one embodiment, the first credential is determined by the UDM in the core network device according to the PINE identifier of the PINE and/or the PEGC identifier of the PEGC.

Trigger information that triggers authentication of PINE can be sent to UDM. The UDM may determine the first credential of the PINE based on the PINE identifier and/or the PEGC identifier of the PEGC.

The first credential may be stored in UDM, and XRES* may be determined by UDM, thereby initiating identity authentication for PINE.

XRES* can be used to be compared with the RES* calculated by PINE to confirm whether the second credential of PINE is the same as the first credential in UDM, thereby determining the identity of PINE and completing the identity authentication of the PINE. UDM can include an authentication credential repository and processing function (ARPF).

Illustratively, for each Nudm_Authenticate_Get Request shown in FIG. 3, UDM/ARPF creates a 5G HE AV for PINE according to the locally stored PINE credential, that is, the first credential. UDM/ARPF achieves this by generating an AV with the Authentication Management Field (AMF) separation bit set to “1”. UDM/ARPF can then calculate XRES*. UDM/ARPF can create a 5G HE AV, and the 5G HE AV can include: RAND, authentication token AUTN, and XRES*.

Before UDM determines XRES*, UDM can also determine whether PEGC is a legal gateway of PINE: first, UDM can determine whether PEGC is a legal gateway in the first type network based on the judgment information. For example, UDM can make judgments based on the PEGC identifier. Then UDM can determine whether PEGC is a legal gateway of PINE. For example, it can determine whether PEGC is allowed to make PINE access the first type network. The UDM may make a determination based on the PEGC identifier, the PINE identifier of the PINE, and the subscription information of PEGC. For example, when the subscription information of PEGC identified by the PEGC identifier has the PINE identifier of PINE, the PEGC is determined to be the legal gateway of PINE.

The judgment information includes at least one of the following: the PEGC identifier of the PEGC; the PINE identifier of the PINE; and the subscription information of the PEGC. The PEGC identifier may include: a user concealed identifier (Subscriptionconcealed Identifier, SUCI) and/or a user permanent identifier (Subscription Permanent Identifier, SUPI).

In one embodiment, the calculation parameter includes at least a random number RAND.

The calculation parameter can be a random number used to calculate XRES*.

In one embodiment, the method further includes: determining an authentication parameter based on at least the second credential and the calculation parameter;
transmitting the authentication information during the identity authentication procedure of the PINE by the core network device of the first type network includes:
sending the RES* to the PEGC through the second type network, where the RES* is used to be sent by the PEGC to the core network device via the base station through the first type network, and the core network device performs identity authentication on the PINE based on at least the RES* and the expected authentication parameter.

After determining XRES*, the core network device can send the calculation parameter to PEGC of PINE through the second type network. Here, the calculation parameter can be sent by PEGC to PINE, and PINE determines RES* based on the second credential, the calculation parameter, etc. The second credential may be determined by the first network, for example, it may be determined by the core network device of the first network. It can be sent by the first network to PINE via PEGC.

The core network device can determine whether the identity authentication of PINE is successful based on the comparison result of RES* and XRES*.

If the first credential is the same as the second credential, then the RES* and XRES* determined based on the same calculation parameter is also the same, then the identity authentication of PINE is successful.

If the first credential and the second credential are not the same, then the RES* and XRES* determined based on the same calculation parameter are also different, and the identity authentication of PINE fails.

In a possible implementation, performing identity authentication on the PINE based on the RES* and the XRES* may also include:
performing identity authentication on the PINE based on the HRES* determined according to RES* and the HRES* determined according to XRES*.

In one embodiment, receiving the calculation parameter sent by the PEGC through the second type network includes:
receiving, through the second type network, a PINE authentication request carrying the calculation parameter sent by the PEGC;
sending the authentication parameter to the PEGC through the second type network includes:
sending a PINE authentication response carrying the authentication parameter sent to the PEGC through the second type network.

UDM can carry the calculation parameter (such as RAND) in the UDM response and send it to AUSF. The UDM response may be Nudm_UEAuthentication_Get Response. For example, UDM can return 5G HE AV to AUSF in Nudm_UEAuthentication_Get Response. 5G HE AV can include: RAND, AUTN and XRES*. The UDM response may carry a PINE authentication indicator indicating identity authentication of the PINE. AUSF may determine the UDM response for authentication to PINE based on the PINE authentication indicator.

If the PINE identifier and SUCI of PEGC are included in Nudm_UEAuthentication_Get Request, UDM includes the PINE identifier and the SUPI of PEGC in Nudm_UEAuthentication_Get Response after deconcealment of SUCI by SIDF.

AUSF can store XRES*, PINE identifier and SUPI. Then, AUSF can calculate HXRES* from XRES*. AUSF can generate 5G AV according to the 5G HE AV received from UDM/ARPF and replace XRES* with HXRES*. 5G HE AV can include: RAND, AUTN, HXRES*.

AUSF can return 5G SE AV (RAND, AUTN, HXRES*), PINE authentication indicator, SUPI of PEGC, and PINE identifier to SEAF in the AUSF response (such as Nausf_UEAuthentication_Authenticate Response). SEAF can store received HXRES*.

SEAF can send the PINE authentication indicator, RAND, AUTN, and PINE identifier to PEGC in the authentication request (such as NAS message). The authentication request can be an Authentication Request.

In one embodiment, the PINE authentication request also carries a service network identifier.

PEGC may forward the SN-name. RAND, AUTN and PINE authentication indicator received in the authentication request to PINE through the secure non-3GPP second network. PEGC may carry the calculation parameter and/or the SN-Name in the PINE authentication request.

After PINE receives the RAND, AUTN and SN-Name carried in the PINE authentication request, PINE can determine whether it can accept the PINE authentication request by checking the AUTN. For example, PINE can verify the freshness of received AUTN. If PINE determines that the PINE authentication request is acceptable, then PINE may calculate RES*. For example, PINE can first calculate RES, CK, and IK, and then PINE ME can calculate RES* from RES.

After PINE determines RES*, it can send RES* to the core network device.

PINE can return a PINE authentication response to PEGC through a secure non-3GPP second type network. The PINE authentication response can include: RES*, PINE identifier and PINE authentication indicator. The PINE authentication response may be PINE Authentication Response.

PEGC may send an authentication response to SEAF in a NAS message, where the authentication response may include: RES*, PINE identifier and PINE authentication indicator. The authentication response may be: Authentication Response.

SEAF can send RES*, PINE identifier, PINE authentication indicator and SUPI of PEGC to AUSF in the A USF authentication request (Nausf_UEAuthentication_Authenticate Request).

In one embodiment, the expected authentication parameter is determined based on at least the first credential, the calculation parameter and the service network identifier;
determining the authentication parameter based on at least the second credential and the calculation parameter includes:
determining the authentication parameter based on at least the second credential, the calculation parameter and the service network identifier.

For example, the core network device may determine XRES* based on a predetermined calculation method and at least one of the following:

$$FC = 0 x 6 B ;$$

$$P 0 = SN - Name service network identifier ;$$

$$L 0 = length of service network identifier ;$$

$$P 1 = calculation parameter , i . e . RAND ;$$

$$L 1 = length of RAND ( such as : 0 x 00 , 0 x 10 ) ;$$

$$P 2 = XRES ;$$

$$L 2 = length of XRES ( such as the following variable lengths : 0 x 00 \; 0 x 04 and 0 x 00 \; 0 x 10 ) .$$

The core network device can send the calculation parameter and/or SN-Name to PINE, and PINE determines RES* in combination with the stored second credential. PINE can determine RES* based on the above-mentioned similar method, which will not be described again here.

SEAF can calculate HRES* through RES*, and SEAF can compare HRES* with HXRES*. For example, SEAF may locate HXRES* of PINE based on the PINE identifier and/or SUPI of PEGC. If they coincide, SEAF will consider the authentication as successful from the serving network point of view. If not, SEAF can determine that authentication was not successful. If the SEAF never receives the RES*, the SEAF considers the authentication to have failed and indicate to the AUSF that the identity authentication of PINE failed.

When AUSF receives the AUSF authentication request (Nausf_UEAuthentication_Authenticate Request message) including RES* as the authentication confirmation, it can verify whether the 5G AV has expired. If the 5G AV has expired, AUSF may consider the PINE identity authentication unsuccessful. AUSF compares the received RES* with the stored XRES*. If the RES* and the XRES* are equal, the AUSF considers the authentication successful from the home network point of view. AUSF notifies UDM of the authentication result.

In a possible implementation, the AUSF can indicate to the SEAF whether the identity authentication of PINE is successful from the home network point of view in the AUSF authentication response (Nausf_UEAuthentication_Authenticate Response).

In a possible implementation, SEAF can determine HRES* according to RES*, and AUSF can determine HXRES* according to XRES*. SEAF and AUSF can determine HRES* and HXRES* respectively using the SHA-256 hash algorithm. The parameter used by the SHA-256 hashing algorithm includes but is not limited to:

$$P 0 = calculation parameter ( such as RAND ) ;$$

$$P 1 = RES * or XRES * ,$$

input S is equal to the series concatenation of P0 and P1: P0∥P1. HRES* and HXRES* are identified by the 128 least significant bits output by the SHA-256 function.

In one embodiment, the authentication parameter, the expected authentication parameter, the hash authentication parameter and the hash expected authentication parameter are identified by at least one of the following:
a PINE identifier of the PINE;
a PEGC identifier of the PEGC.

In a possible implementation, RES*, XRES*, HRES*, and HXRES* may have a PINE identifier that indicates the corresponding PINE, and/or a PEGC identifier that indicates the corresponding PEGC. When the core network device stores RES*, XRES*, HRES*, and/or HXRES*, it may use the PINE identifier and/or the PEGC identifier for identification. For example, SEAF may use the PINE identifier when storing XRES* and HXRES*.

In a possible implementation, during the transmission process of RES*, XRES*, HRES* and/or HXRES*, the PINE identifier and/or PEFC identifier carried in the transmission message can be used for identification. The transmission message may include at least one of the following: the UDM response, the AUSF response, the authentication request, the authentication response, the PINE authentication request, the PINE authentication response, and the AUSF authentication request.

In one embodiment, the PINE authentication request and/or the PINE authentication response carries at least one of the following:
a PINE authentication indicator, used to indicate to perform identity authentication on the PINE;
a subscription permanent identifier (SUPI), used to indicate the PEGC.

Here, the PINE authentication indicator can indicate to the core network device (such as UDM, AUSF, SEAF), PEGC, and PINE that the received message is used for identity authentication of PINE.

SUPI can indicate to the core network device (such as UDM, AUSF, SEAF), PEGC, and PINE, the PEGC connected to the PINE on which identity authentication is performed. The core network device and/or PINE may send corresponding information to the PEGC indicated by SUPI.

In one embodiment, the PINE authentication request and/or the PINE authentication response carries a PINE identifier indicating the PINE.

Here, the PINE authentication indicator can indicate to the core network device and PEGC, the PINE on which identity authentication is performed.

In one embodiment, the PINE identifier is a security-protected PINE identifier.

The security-protected PINE identifier may include an encrypted PINE identifier, an anonymous PINE identifier, etc.

In a possible implementation, at least one of the UDM response, the AUSF response, the authentication request, the PINE authentication request, the PINE authentication response, the authentication response and the AUSF authentication request carries the security-protected PINE identifier.

In one embodiment, the PINE identifier is a security-protected PINE identifier.

When the PINE identifier received by the core network device network element (such as UDM) is a protected PINE identifier, it needs to convert the protected PINE identifier into a PINE identifier in plaintext state through deanonymization, decryption, etc.

When the core network device transmits within the core network device, the PINE identifier in plaintext state can be used. For example, at least one of the authentication request, the PINE authentication request, the PINE authentication response, and the authentication response carries the security-protected PINE identifier.

When the PINE identifier is transmitted outside the core network device, the protected PINE identifier can be used. That is, in the communications among SEAF-PEGC-PINE, a protected PINE identifier is used, for example, at least one of the authentication request, the PINE authentication request, the PINE authentication response and the authentication response carries the security-protected PINE identifier.

In a possible implementation, if the PINE identifier received by UDM is unprotected information (that is, the PINE identifier in plaintext state), in the communication among SEAF-PEGC-PINE, unprotected information (PINE identifier in plaintext state) is used. For example, at least one of the authentication request, the PINE authentication request, the PINE authentication response, and the authentication response carries a PINE identifier in plaintext state.

In related art, UDM needs to determine the Kausf during the identity authentication procedure. Here, during the PINE identity authentication procedure, it is unnecessary for the UDM to determine Kausf and the UDM no longer transmits the Kausf, thereby reducing the load of the core network device. The authentication service function key Kausf generates security anchor function key Kseaf.

In related art, AUSF needs to determine Kseaf during the identity authentication procedure. Here, during the PINE identity authentication procedure, AUSF needs not to determine Kseaf and no longer transmit Kseaf, thereby reducing the load of the core network device. The key set identifier ngKSI is the identifier of the key set used by the UE in the first type network, and is used to indicate that the first type network uses the same key set as the UE. The ABBA parameter is used by the AMF network element to generate KAMF. The key set identifier (ngKSI, key setidentifier in 5G) may be used to create a local security context after successful authentication, and the anti-bidding down between architectures (ABBA) parameter can be used to differentiate version security feature indication parameters to prevent confusion.

PINE accesses the first type network through PEGC. Therefore, SEAF can no longer determine the ngKSI and ABBA parameters and no longer transmit them, thereby reducing the load of the core network device.

A specific example is provided below in combination with any of the above embodiments.

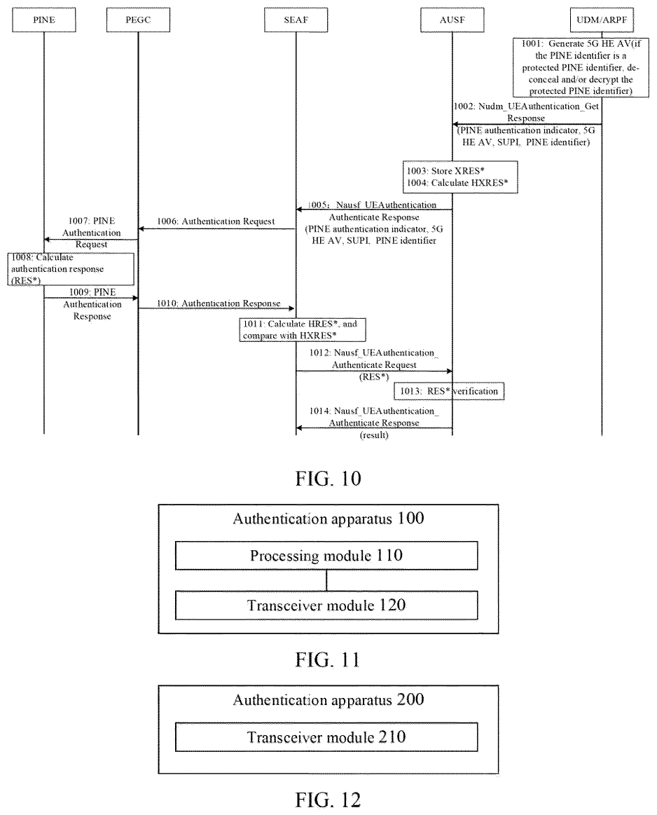

PINE authentication is shown in FIG. 10. Here, it is assumed that the PINE identifier is encrypted. UDM may invoke a function to decrypt the encrypted PINE identifier.

It is assumed that the UDM can identify the credential of the PINE according to the encrypted device identifier of PINE or device identifier of PINE. It is also assumed that PINE is connected to PEGC via secure non-3GPP access.

The identity authentication of PINE specifically includes the following.

In step 1001: 5G HE AV is generated. It is assumed that the UDM can identify the PINE credential according to the decrypted PINE identifier or the PINE identifier. It is also assumed that PINE connects to PEGC via secure non-3GPP access. For each Nudm_Authenticate_Get request shown in FIG. 3, the UDM/ARPF may create a 5G HE AV according to the locally stored PINE credential. The UDM/ARPF achieves this by generating an AV with the Authentication Management Field (AMF) separation bit set to “1” as defined in TS 33.102[9]. The UDM/ARPF may then calculate XRES* (as per Annex A.4). Finally, the UDM/ARPF may create a 5G HE AV from RAND, AUTN and XRES*. If the PINE identifier is a protected PINE identifier (such as an anonymous PINE identifier, or an encrypted PINE identifier), the protected PINE identifier is de-concealed and/or decrypted. In step 1002: the UDM may return the 5G HE AV and the PINE authentication indicator to the AUSF together with an indication that the 5G HE AV is to be used for 5G AKA in a Nudm_UEAuthentication_Get response.

If the PINE identifier and SUCI of PEGC are included in the Nudm_UEAuthentication_Get request, UDM will include the PINE identifier and SUPI of PEGC in the Nudm_UEAuthentication_Get response after deconcealment of SUCI by SIDF.

In step 1003: the AUSF may store the XRES* temporarily together with the received PINE identifier and SUPI of PEGC.

In step 1004: the AUSF may generate the 5G AV from the 5G HE AV received from the UDM/ARPF by computing the HXRES* from XRES* (according to Annex A.5 of 33.501[1]), and replace the XRES* with the HXRES*.

In step 1005: the AUSF may return the 5G SE AV (RAND, AUTN, HXRES*), PINE authentication indicator, SUPI of PEGC, and PINE identifier to the SEAF in a Nausf_UEAuthentication_Authenticate response.

In step 1006: the SEAF may send PINE authentication indicator, RAND, AUTN, and PINE identifier to the PEGC in a NAS message Authentication Request. If the PEGC identifier sent by the PEGC to the SEAF is a protected PINE identifier, the SEAF sends the protected PINE identifier to the PEGC at this time.

In step 1007: the PEGC may forward the SN-Name, RAND, AUTN and PINE authentication indicator received in the NAS message Authentication Request to the PINE through the PINE Authentication Request via secure non-3GPP connection.

In step 1008: at receipt of RAND, AUTN, and SN-Name, the PINE may verify the freshness of the received values by checking whether the AUTN can be accepted as described in TS 33.102 [9]. If so, the PINE computes RES. The PINE may calculate RES, CK, and IK. The PINE may then compute the authentication response RES* from RES according to Annex A.4 of 33.501.

In step 1009: the PINE may return RES*, PINE identifier, and PINE authentication indicator to the PEGC via secure non-3GPP access.

In step 1010: the PEGC may send the RES*, PINE identifier, PEGC identifier and PINE authentication indicator to SEAF in a NAS message Authentication Response.

In step 1011: the SEAF may then calculate HRES* from RES* according to Annex A.5 of 33.501, and the SEAF may compare HRES* and HXRES*. Specifically, SEAF may be able to locate HXRES* of a specific PINE according to the PINE identifier and SUPI of PEGC. If they coincide, the SEAF considers the authentication successful from the serving network point of view. If not, the SEAF proceeds as described in sub-clause 6.1.3.2.2 of 33.501. If the PINE is not reached, and the RES* is never received by the SEAF, the SEAF may consider authentication as failed, and indicate a failure to the AUSF.

In step 1012: the SEAF can send RES*, SUPI of PEGC, PINE identifier and PINE authentication indicator in the Nausf_UEAuthentication_Authenticate Request message to the AUSF.

In step 1013: when the AUSF receives the Nausf_UEAuthentication_Authenticate Request message including RES* as authentication confirmation, it may verify whether the 5G AV has expired. If the 5G AV has expired, the AUSF may consider the authentication as unsuccessful from the home network point of view. The AUSF may compare the received RES* with the stored XRES*. If the RES* and the XRES* are equal, the AUSF may consider the authentication as successful from the home network point of view. The AUSF may inform UDM about the authentication result.

In step 1014: the AUSF may indicate to the SEAF in the Nausf_UEAuthentication_Authenticate Response whether the authentication was successful or not from the home network point of view.

As shown in FIG. 11, this exemplary embodiment provides an authentication apparatus 100, which can be performed by the core network device of the cellular mobile communication system, and includes:
a processing module 110, configured to perform an identity authentication on a PINE, where the PINE accesses a first type network through a PIN element with gateway capability (PEGC), and the PINE and the PEGC are connected through a second type network.

In one embodiment, the processing module 110 is specifically configured to:
determine an expected authentication parameter based on at least a first credential and a calculation parameter of the PINE;
perform the identity authentication on the PINE based on the expected authentication parameter.

In one embodiment, the first credential is stored in the core network device.

In one embodiment, the first credential is determined by the core network device based on a PINE identifier of the PINE and/or a PEGC identifier of the PEGC.

In one embodiment, the apparatus 100 further includes:
a transceiver module 120, configured to send the calculation parameter to the PEGC via a base station through the first type network, where the calculation parameter is sent by the PEGC to the PINE through the second type network;
the transceiver module 120 is further configured to receive an authentication parameter sent by the PEGC via the base station through the first type network, the authentication parameter is generated by the PINE based on at least a second credential and the calculation parameter, and is sent to the PEGC through the second type network;
the processing module 110 is specifically configured to perform the identity authentication on the PINE based on the authentication parameter and the expected authentication parameter.

In one embodiment, the transceiver module 120 is specifically configured to:
send, by a unified data management (UDM) in the core network device, a UDM response carrying the calculation parameter to an authentication service function (AUSF) in the core network device;
send, by the AUSF, an AUSF response carrying the calculation parameter to a security anchor function (SEAF) in the core network device;
send, by the SEAF, an authentication request carrying the calculation parameter to the PEGC via the base station through the first type network.

In one embodiment, the transceiver module 120 is specifically configured to perform at least one of the following:
the SEAF receiving an authentication response carrying the authentication parameter sent by the PEGC via the base station through the first type network, where the authentication parameter is carried by the PINE in a PINE authentication response and sent to the PEGC through the second type network;
the AUSF receiving an AUSF authentication request carrying the authentication parameter sent by the SEAF.

In one embodiment, the processing module 110 is specifically configured to perform at least one of the following:
the SEAF determining a hash authentication parameter according to the authentication parameter, and performing the identity authentication on the PINE based on the hash authentication parameter and a hash expectation authentication parameter, where the hash expectation authentication parameter is determined based on the expected authentication parameter and sent to the SEAF by the AUSF;
the AUSF performing the identity authentication on the PINE based on the authentication parameter and the expected authentication parameter.

In one embodiment, the authentication parameter, the expected authentication parameter, the hash authentication parameter and the hash expected authentication parameter are identified by at least one of the following:
a PINE identifier of the PINE;
a PEGC identifier of the PEGC.

In one embodiment, at least one of the UDM response, the AUSF response, the authentication request, the authentication response, the PINE authentication request, the PINE authentication response and the AUSF authentication request carries at least one of the following:
a PINE authentication indicator, used to indicate to perform the identity authentication on the PINE;
a subscription permanent identifier (SUPI), used to indicate the PEGC.

In one embodiment, the PINE authentication indicator is used to indicate that the core network device does not perform at least one of the following:
generating an authentication service function key Kausf;
generating a security anchor function key Kseaf;
sending a key set identifier ngKSI to the PEGC;
sending an anti-bidding down between architectures (ABBA) parameter to the PEGC.

In one embodiment, at least one of the UDM response, the AUSF response, the authentication request, the PINE authentication request, the PINE authentication response, the authentication response and the AUSF authentication request carries a PINE identifier indicating the PINE.

In one embodiment, the PINE identifier is a security-protected PINE identifier.

In one embodiment, the processing module 110 is further configured to, in response to the PINE identifier being a security-protected PINE identifier, restore the security-protected PINE identifier to a PINE identifier in a plaintext state;
at least one of the UDM response, the AUSF response and the AUSF authentication request carries the PINE identifier in the plaintext state;
at least one of the authentication request, the PINE authentication request, the PINE authentication response, and the authentication response carries the security-protected PINE identifier.

In one embodiment, the processing module 110 is further configured to: determine whether the PEGC is a legal gateway for the PEGC to access the first type network based on judgment information, where the judgment information includes at least one of the following:
a PEGC identifier of the PEGC;
a PINE identifier of the PINE;
subscription information of the PEGC;
determining the expected authentication parameter based on at least the first credential and the calculation parameter of the PINE, includes:
determining that the PEGC is the legal gateway;
determining the expected authentication parameter based on the first credential and the calculation parameter of the PINE.

In one embodiment, the processing module 110 is specifically configured to: determine the expected authentication parameter based on at least the first credential, the calculation parameter and a service network identifier;
the authentication parameter is determined by the PINE based on at least a second credential, the calculation parameter and the service network identifier.

In one embodiment, the calculation parameter and/or the service network identifier are sent by the PEGC to the PINE through the second type network.

In one embodiment, the calculation parameter includes at least a random number RAND.

In one embodiment, the first credential is determined by the UDM in the core network device according to a PINE identifier of the PINE and/or a PEGC identifier of the PEGC.

In one embodiment,
the first type network includes: the 3rd generation partnership project (3GPP) standard network;
the second type network includes: non-3GPP standard network.

As shown in FIG. 12, this exemplary embodiment provides an authentication apparatus 200, which can be performed by a PIN element with gateway capability (PEGC) of the cellular mobile communication system, and includes:
a transceiver module 210, configured to transmit authentication information during an identity authentication procedure of a PINE by a core network device of a first type network, where the PINE accesses the first type network through the PEGC, and the PINE and the PEGC are connected through a second type network.

In one embodiment, the transceiver module 210 is specifically configured to:
receive a calculation parameter sent by the core network device to the PEGC via a base station through the first type network; where the calculation parameter is used to determine an expected authentication parameter by the core network device in combination with at least a first credential, and the expected authentication parameter is used for the core network device to perform an identity authentication on the PINE.

In one embodiment, the first credential is determined by the core network device based on a PINE identifier of the PINE and/or a PEGC identifier of the PEGC.

In one embodiment, the transceiver module 210 is specifically configured to:
send the calculation parameter to the PINE through the second type network;
receive an authentication parameter sent by the PINE through the second type network, where the authentication parameter is determined by the PINE based on at least a second credential and the calculation parameter;
send the authentication parameter to the core network device via the base station through the first type network, where the authentication parameter is used for the core network device to perform identity authentication on the PINE based on at least the expected authentication parameter.

In one embodiment, the transceiver module 210 is specifically configured to perform at least one of the following:
receiving an authentication request carrying the calculation parameter sent by a SEAF in the core network device via the base station through the first type network;
sending a PINE authentication request carrying the calculation parameter to the PINE through the second type network;
receiving a PINE authentication response carrying the authentication parameter sent by the PINE through the second type network;
sending an authentication response carrying the authentication parameter to the SEAF via the base station through the first type network.

In one embodiment, the PINE authentication request further carries a service network identifier.

In one embodiment, the expected authentication parameter is determined by the core network device based on at least the first credential, the calculation parameter and the service network identifier.

The authentication parameter is determined by the PINE based on at least the second credential, the calculation parameter and the service network identifier.

In one embodiment, at least one of the authentication request, the authentication response, the PINE authentication request and the PINE authentication response carries at least one of the following:
a PINE authentication indicator, used to indicate to perform identity authentication on the PINE;
a subscription permanent identifier (SUPI), used to indicate the PEGC.

In one embodiment, at least one of the authentication request, the PINE authentication request, the PINE authentication response, and the authentication response carries a PINE identifier indicating the PINE.

In one embodiment, the PINE identifier is a security-protected PINE identifier.

In one embodiment, the calculation parameter includes at least a random number RAND.

In one embodiment, the first credential is determined by the UDM in the core network device according to a PINE identifier of the PINE and/or a PEGC identifier of the PEGC.

In one embodiment, the PEGC includes a user equipment WE).

In one embodiment,
the first type network includes: the 3rd generation partnership project (3GPP) standard network;
the second type network includes: a non-3GPP standard network.

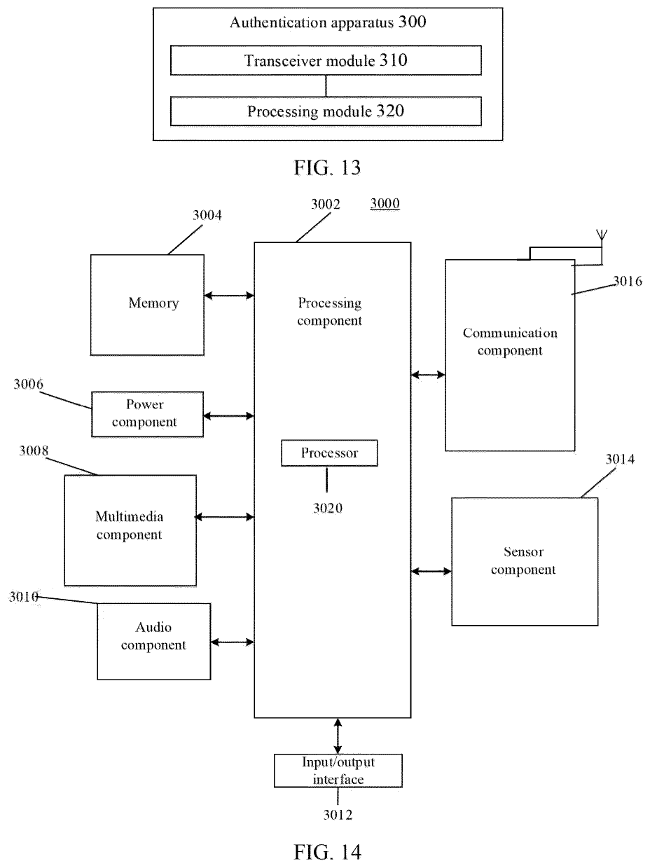

As shown in FIG. 13, this exemplary embodiment provides an authentication apparatus 300 that can be performed by PINE, including:
a transceiver module 310, configured to transmit authentication information during an identity authentication procedure of the PINE by a core network device of a first type network, where the PINE accesses the first type network through a PIN element with gateway capability (PEGC), and the PINE and the PEGC are connected through a second type network.

In one embodiment, the transceiver module 310 is specifically configured to:
receive a calculation parameter sent by the PEGC through the second type network, where the calculation parameter is sent by the core network device to the PEGC via a base station through the first type network, the calculation parameter is used by the core network device to determine an expected authentication parameter in combination with at least a first credential, and the expected authentication parameter is used for the core network device to perform identity authentication on the PINE.

In one embodiment, the first credential is determined by the core network device according to a PINE identifier of the PINE and/or a PEGC identifier of the PEGC.

In one embodiment, the apparatus further includes: a processing module 320, configured to determine an authentication parameter based on at least a second credential and the calculation parameter;
the transceiver module 310 is specifically configured to: send the authentication parameter to the PEGC through the second type network, where the authentication parameter is used to be sent by the PEGC to the core network device via the base station through the first type network, and identity authentication is performed by the core network device on the PINE based on at least the authentication parameter and the expected authentication parameter.

In one embodiment, the transceiver module 310 is specifically configured to perform at least one of the following:
receiving, through the second type network, a PINE authentication request carrying the calculation parameter sent by the PEGC;
sending a PINE authentication response carrying the authentication parameter to the PEGC through the second type network.

In one embodiment, the PINE authentication request further carries a service network identifier.

In one embodiment, the expected authentication parameter is determined based on at least the first credential, the calculation parameter and a service network identifier,
the processing module is specifically configured to:
determine the authentication parameter based on at least the second credential, the calculation parameter and the service network identifier.

In one embodiment, the PINE authentication request and/or the PINE authentication response carries at least one of the following:
a PINE authentication indicator, used to indicate to perform identity authentication of the PINE;
a subscription permanent identifier (SUPI), used to indicate the PEGC.

In one embodiment, the PINE authentication request and/or the PINE authentication response carries a PINE identifier indicating the PINE.

In one embodiment, the PINE identifier is a security-protected PINE identifier.

In one embodiment, the calculation parameter includes at least a random number RAND.

In one embodiment, the first credential is determined by the UDM in the core network device according to a PINE identifier of the PINE and/or a PEGC identifier of the PEGC.

In one embodiment,
the first type network includes: the 3rd generation partnership project (3GPP) standard network;
the second type network includes: non-3GPP standard network.

In an exemplary embodiment, the processing module 110, the transceiver module 120, the transceiver module 210, the transceiver module 310, the processing module 320, etc. may be implemented by one or more central processing units (CPUs), graphics processing units (GPUs), baseband processors (BPs), application specific integrated circuit (ASICs), DSPs, programmable logic devices (PLDs), complex programmable logic devices (CPLDs), Field-Programmable Gate Arrays (FPGAs), general-purpose processors, controllers, Micro Controller Units (MCUs), microprocessors, or other electronic components, for performing the above described methods.

FIG. 14 is a block diagram of an apparatus 3000 for authentication according to an exemplary embodiment. For example, the apparatus 3000 may be a mobile phone, a computer, a digital broadcast terminal, a messaging device, a gaming console, a tablet, a medical device, exercise equipment, a personal digital assistant, or the like.

Referring to FIG. 14, the apparatus 3000 may include one or more of the following components: a processing component 3002, a memory 3004, a power component 3006, a multimedia component 3008, an audio component 3010, an input/output (I/O) interface 3012, a sensor component 3014, and a communication component 3016.

The processing component 3002 typically controls overall operations of the apparatus 3000, such as the operations associated with display, telephone calls, data communications, camera operations, and recording operations. The processing component 3002 may include one or more processors 3020 to execute instructions to perform all or part of the steps in the above described methods. Moreover, the processing component 3002 may include one or more modules which facilitate the interaction between the processing component 3002 and other components. For instance, the processing component 3002 may include a multimedia module to facilitate the interaction between the multimedia component 3008 and the processing component 3002.

The memory 3004 is configured to store various types of data to support the operation of the apparatus 3000. Examples of such data include instructions for any applications or methods operated on the apparatus 3000, contact data, phonebook data, messages, pictures, video, etc. The memory 3004 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 3006 provides power to various components of the apparatus 3000. The power component 3006 may include a power management system, one or more power sources, and any other components associated with the generation, management, and distribution of power in the apparatus 3000.

The multimedia component 3008 includes a screen providing an output interface between the apparatus 3000 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 3008 includes a front camera and/or a rear camera. The front camera and the rear camera may receive an external multimedia datum while the apparatus 3000 is in an operation mode, such as a photographing mode or a video mode. Each of the front camera and the rear camera may be a fixed optical lens system or have focus and optical zoom capability.

The audio component 3010 is configured to output and/or input audio signals. For example, the audio component 3010 includes a microphone (“MIC”) configured to receive an external audio signal when the apparatus 3000 is in an operation mode, such as a call mode, a recording mode, and a voice recognition mode. The received audio signal may be further stored in the memory 3004 or transmitted via the communication component 3016. In some embodiments, the audio component 3010 further includes a speaker to output audio signals.

The I/O interface 3012 provides an interface between the processing component 3002 and peripheral interface modules, such as a keyboard, a click wheel, buttons, and the like. The buttons may include, but are not limited to, a home button, a volume button, a starting button, and a locking button.

The sensor component 3014 includes one or more sensors to provide status assessments of various aspects of the apparatus 3000. For instance, the sensor component 3014 may detect an open/closed status of the device 300M, relative positioning of components, e.g., the display and the keypad, of the apparatus 3000, a change in position of the apparatus 3000 or a component of the apparatus 3000, a presence or absence of user contact with the apparatus 3000, an orientation or an acceleration/deceleration of the apparatus 3000, and a change in temperature of the apparatus 3000. The sensor component 3014 may include a proximity sensor configured to detect the presence of nearby objects without any physical contact. The sensor component 3014 may also include a light sensor, such as a CMOS or CCD image sensor, for use in imaging applications. In some embodiments, the sensor component 3014 may also include an accelerometer sensor, a gyroscope sensor, a magnetic sensor, a pressure sensor, or a temperature sensor.

The communication component 3016 is configured to facilitate communication, wired or wirelessly, between the apparatus 3000 and other devices. The apparatus 3000 can access a wireless network based on a communication standard, such as WiFi, 2G, or 3G, or a combination thereof. In one exemplary embodiment, the communication component 3016 receives a broadcast signal or broadcast associated information from an external broadcast management system via a broadcast channel. In one exemplary embodiment, the communication component 3016 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 3000 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 3004, executable by the processor 3020 in the apparatus 3000, for performing the above-described methods. For example, the non-transitory computer-readable storage medium may be a ROM, a RAM, a CD-ROM, a magnetic tape, a floppy disc, an optical data storage device, and the like.

Other implementations of the embodiments of the present disclosure will be apparent to those skilled in the art from consideration of the specification and practice of the contents disclosed here. The present application is intended to cover any variations, uses, or adaptations of the embodiments of the present disclosure, which follows the general principles thereof and includes the common knowledge or habitual technical means in this technical field that is not disclosed in the embodiments of the present disclosure. The specification and embodiments are considered as exemplary only, with a true scope and spirit of the present disclosure being indicated by the appending claims.

It will be appreciated that the embodiments of the present disclosure are not limited to the exact construction that has been described above and illustrated in the accompanying drawings, and various modifications and changes can be made without departing from the scope thereof. The scope of the embodiments of the present disclosure is only limited by the appended claims.

1. An authentication method, performed by a core network device of a first type network, wherein the method comprises:
performing an identity authentication on a personal IoT networks element (PINE), wherein the PINE accesses the first type network through a PIN element with gateway capability (PEGC), and the PINE and the PEGC are connected through a second type network.

2. The method according to claim 1, wherein performing the identity authentication on the personal IoT networks element (PINE) comprises:
determining an expected authentication parameter based on at least a first credential and a calculation parameter of the PINE; and
performing the identity authentication on the PINE based on the expected authentication parameter,
wherein the first credential is stored in the core network device and determined by the core network device according to at least one of a PINE identifier of the PINE or a PEGC identifier of the PEGC.

3-4. (canceled)

5. The method according to claim 2, wherein performing the identity authentication on the PINE based on the expected authentication parameter comprises:
sending the calculation parameter to the PEGC via a base station through the first type network, wherein the calculation parameter is sent by the PEGC to the PINE through the second type network;
receiving an authentication parameter sent by the PEGC via the base station through the first type network, wherein the authentication parameter is determined by the PINE based on at least a second credential and the calculation parameter, and is sent to the PEGC through the second type network; and
performing the identity authentication on the PINE based on the authentication parameter and the expected authentication parameter.

6. The method according to claim 5, wherein sending the calculation parameter to the PEGC via the base station through the first type network comprises:
sending, by a unified data management (UDM) in the core network device, a UDM response carrying the calculation parameter to an authentication service function (AUSF) in the core network device;
sending, by the AUSF, an AUSF response carrying the calculation parameter to a security anchor function (SEAF) in the core network device; and
sending, by the SEAF, an authentication request carrying the calculation parameter to the PEGC via the base station through the first type network.

7. The method according to claim 6, wherein receiving the authentication parameter sent by the PEC via the base station through the first type network comprises at least one of:
receiving, by the SEAF, an authentication response carrying the authentication parameter sent by the PEGC via the base station through the first type network, wherein the authentication parameter is carried by the PINE in a PINE authentication response and sent to the PEGC through the second type network; or
receiving, by the AUSF, an AUSF authentication request carrying the authentication parameter sent by the SEAF.

8. The method according to claim 7, wherein performing the identity authentication on the PINE based on the authentication parameter and the expected authentication parameter comprises at least one of:
determining, by the SEAF, a hash authentication parameter according to the authentication parameter, and performing the identity authentication on the PINE based on the hash authentication parameter and a hash expected authentication parameter, wherein the hash expected authentication parameter is determined based on the expected authentication parameter and sent to the SEAF by the AUSF; or
performing, by the AUSF, the identity authentication on the PINE based on the authentication parameter and the expected authentication parameter,
wherein the authentication parameter, the expected authentication parameter, the hash authentication parameter and the hash expected authentication parameter are identified using at least one of:
a PINE identifier of the PINE; or
a PEGC identifier of the PEGC.

9. (canceled)

10. The method according to claim 7, wherein at least one of the UDM response, the AUSF response, the authentication request, the authentication response, a PINE authentication request, the PINE authentication response, or the AUSF authentication request carries at least one of:
a PINE authentication indicator, used to indicate to perform the identity authentication on the PINE;
a subscription permanent identifier (SUP)), used to indicate the PEGC; or
a PINE identifier indicating the PINE,
wherein the method further comprises: in response to the PINE identifier being a security-protected PINE identifier, restoring the security-protected PINE identifier to a PINE identifier in a plaintext state;
at least one of the UDM response, the AUSF response, or the AUSF authentication request carries the PINE identifier in the plaintext state;
at least one of the authentication request, the PINE authentication request, the PINE authentication response, or the authentication response carries the security-protected PINE identifier.

11-12. (canceled)

13. The method according to claim 2, wherein the method further comprises: determining whether the PEGC is a legal gateway for the PEGC to access the first type network based on judgment information, wherein the judgment information comprises at least one of:
a PEGC identifier of the PEGC;
a PINE identifier of the PINE; or
subscription information of the PEGC;
determining the expected authentication parameter based on at least the first credential and the calculation parameter of the PINE, comprises:
determining that the PEGC is the legal gateway;
determining the expected authentication parameter based on the first credential and the calculation parameter of the PINE.

14. The method according to claim 5, wherein determining the expected authentication parameter based on at least the first credential and the calculation parameter of the PINE comprises:
determining the expected authentication parameter based on the first credential, the calculation parameter and a service network identifier;
wherein the authentication parameter is determined by the PINE based on at least a second credential, the calculation parameter and the service network identifier,
wherein at least one of the calculation parameter or the service network identifier is sent by the PEGC to the PINE through the second type network.

15-17. (canceled)

18. An authentication method, performed by a PIN element with gateway capability (PEGC), comprising:
transmitting authentication information during an identity authentication procedure of a personal IoT networks element (PINE) by a core network device of a first type network, wherein the PINE accesses the first type network through the PEGC, and the PINE and the PEGC are connected through a second type network.

19. The method according to claim 18, wherein transmitting the authentication information during the identity authentication procedure of the PINE by the core network device of the first type network, comprises:
receiving a calculation parameter sent by the core network device to the PEGC via a base station through the first type network; wherein the calculation parameter is used to determine an expected authentication parameter by the core network device in combination with at least a first credential, and the expected authentication parameter is used for the core network device to perform an identity authentication on the PINE,
wherein the first credential is determined by the core network device based on at least one of a PINE identifier of the PINE or a PEGC identifier of the PEGC.

20. (canceled)

21. The method according to claim 19, wherein transmitting the authentication information during the identity authentication procedure of the PINE by the core network device of the first type network, comprises:
sending the calculation parameter to the PINE through the second type network;
receiving an authentication parameter sent by the PINE through the second type network, wherein the authentication parameter is determined by the PINE based on at least a second credential and the calculation parameter;
sending the authentication parameter to the core network device via the base station through the first type network, wherein the authentication parameter is used for the core network device to perform the identity authentication on the PINE based on at least the expected authentication parameter.

22. The method according to claim 21, wherein receiving the calculation parameter sent by the core network device to the PEGC via the base station through the first type network comprises:
receiving an authentication request carrying the calculation parameter sent by a security anchor function (SEAF) in the core network device via the base station through the first type network;
sending the calculation parameter to the PINE through the second type network comprises:
sending a PINE authentication request carrying the calculation parameter to the PINE through the second type network;
receiving the authentication parameter sent by the PINE through the second type network comprises:
receiving a PINE authentication response carrying the authentication parameter sent by the PINE through the second type network;
sending the authentication parameter to the core network device via the base station through the first type network comprises:
sending an authentication response carrying the authentication parameter to the SEAF via the base station through the first type network.

23. The method according to claim 22, wherein the PINE authentication request further carries a service network identifier, wherein
the expected authentication parameter is determined by the core network device based on at least the first credential, the calculation parameter and the service network identifier;
the authentication parameter is determined by the PINE based on at least the second credential, the calculation parameter and the service network identifier.

24. (canceled)

25. The method according to claim 22, wherein at least one of the authentication request, the authentication response, the PINE authentication request, or the PINE authentication response carries at least one of:
a PINE authentication indicator, used to indicate to perform the identity authentication on the PINE;
a subscription permanent identifier (SUPI), used to indicate the PEGC; or
a PINE identifier indicating the PINE.

26. (canceled)

27. An authentication method, performed by a personal IoT networks element (PINE), comprising:
transmitting authentication information during an identity authentication procedure of the PINE by a core network device of a first type network, wherein the PINE accesses the first type network through a PIN element with gateway capability (PEGC), and the PINE and the PEGC are connected through a second type network.

28. The method according to claim 27, wherein transmitting the authentication information during the identity authentication procedure of the PINE by the core network device of the first type network comprises:
receiving a calculation parameter sent by the PEGC through the second type network, wherein the calculation parameter is sent by the core network device to the PEGC via a base station through the first type network, the calculation parameter is used by the core network device to determine an expected authentication parameter in combination with at least a first credential, and the expected authentication parameter is used for the core network device to perform an identity authentication on the PINE,
wherein the first credential is determined by the core network device according to at least one of a PINE identifier of the PINE or a PEFCPEGC identifier of the PEGC,
wherein the method further comprises:
determining an authentication parameter based on at least a second credential and the calculation parameter;
transmitting the authentication information during the identity authentication procedure of the PINE by the core network device of the first type network comprises:
sending the authentication parameter to the PEGC through the second type network, wherein the authentication parameter is used to be sent by the PEGC to the core network device via the base station through the first type network, and the identity authentication is performed by the core network device on the PINE based on at least the authentication parameter and the expected authentication parameter.

29-30. (canceled)

31. The method according to claim 30, wherein
receiving the calculation parameter sent by the PEGC through the second type network comprises:
receiving, through the second type network, a PINE authentication request carrying the calculation parameter sent by the PEGC;
sending the authentication parameter to the PEGC through the second type network comprises:
sending a PINE authentication response carrying the authentication parameter to the PEGC through the second type network.

32. The method according to claim 30, wherein the PINE authentication request further carries a service network identifier, wherein
the expected authentication parameter is determined based on at least the first credential, the calculation parameter and the service network identifier;
determining the authentication parameter based on at least the second credential and the calculation parameter comprises:
determining the authentication parameter based on at least the second credential, the calculation parameter and the service network identifier.

33. (canceled)

34. The method according to claim 31, wherein at least one of the PINE authentication request or the PINE authentication response carries at least one of:
a PINE authentication indicator, used to indicate to perform the identity authentication on the PINE;
a subscription permanent identifier (SUPI), used to indicate the PEGC; or
a PINE identifier indicating the PINE.

35-40. (canceled)
